(19) United States
(12) Patent Application Publication
(10) Pub. No.: US 2025/0306377 A1
(43) Pub. Date: Oct. 2, 2025

(54) Anamorphic near-eye display apparatus

(71) Applicant: RealD Spark, LLC, Boulder, CO (US)

(72) Inventors: Michael G. Robinson, BOULDER, CO (US); Austin Wilson, Tempe, AZ (US); Graham J. Woodgate, Henley-on-Thames (GB)

(21) Appl. No.: 19/059,736

(22) Filed: Feb. 21, 2025

Related U.S. Application Data
(60) Provisional application No. 63/559,735, filed on Feb. 29, 2024.
(60) Provisional application No. 63/720,468, filed on Nov. 14, 2024.

(51) Int. Cl. G02B 27/01; G02B 27/00; G02B 27/09

(52) U.S. Cl. CPC G02B 27/0172; G02B 27/0081; G02B 27/0911; G02B 27/0977; G02B 2027/011; G02B 2027/0123

(57) ABSTRACT

An anamorphic near-eye display apparatus comprises a spatial light modulator with anamorphic pixels; an input transverse anamorphic lens; and an extraction waveguide comprising a lateral anamorphic light reversing reflector. Light from the first spatial light modulator is imaged in the transverse direction by the transverse anamorphic lens, is input into the extraction waveguide and is guided in a first direction along the extraction waveguide. The light is imaged by the lateral anamorphic mirror in the lateral direction and directed in a second direction back through the extraction waveguide. Light extraction features are arranged to direct the reflected light towards the pupil of a viewer. The light extraction features are provided with optical power so that for each point on the spatial light modulator, the output light diverges towards the eye of a viewer. A virtual image plane at a finite viewing distance and correction for ophthalmic conditions may be provided. An efficient near-eye display apparatus for Augmented Reality and Virtual Reality displays is provided.

### TECHNICAL FIELD

This disclosure generally relates to near-eye display apparatuses and illumination systems therefor.

### BACKGROUND

Head-worn displays incorporating a near-eye display apparatus may be arranged to provide fully immersive imagery such as in virtual reality (VR) displays or augmented imagery overlayed over views of the real world such as in augmented reality (AR) displays. If the overlayed imagery is aligned or registered with the real-world image it may be termed Mixed Reality (MR). In VR displays, the near-eye display apparatus is typically opaque to the real world, whereas in AR displays the optical system is partially transmissive to light from the real world.

The near-eye display apparatuses of AR and VR displays aim to provide images to at least one eye of a user with full colour, high resolution, high luminance and high contrast; and with wide fields of view (angular size of image) and large eyebox sizes (the geometry over which the eye can move while having visibility of the full image field of view). Such displays are desirable in thin form factors, low weight and with low manufacturing cost and complexity.

Further, AR near-eye display apparatuses aim to have high transmission of light rays without image distortions or degradations and reduced glare of stray light away from the display wearer. AR optics may broadly be categorised as reflective combiner type or waveguide type. Waveguide types typically achieve reduced form factor and weight due to the optical path folding within the waveguide. Known methods for injecting images into a waveguide may use a spatial light modulator and a projection lens arrangement with a prism or grating to couple light into the waveguide. Pixel locations in the spatial light modulator are converted to a fan of ray directions by the projection lens. In other arrangements a laser scanner may provide the fan of ray directions. The angular locations are propagated through the waveguide and output to the eye of the user. The eye's optical system collects the angular locations and provides spatial images at the retina.

### BRIEF SUMMARY

According to a first aspect of the present disclosure, there is provided an anamorphic near-eye display apparatus comprising: an illumination system comprising a spatial light modulator, the illumination system being arranged to output light; and an optical system arranged to direct light from the illumination system to an eye of a viewer, wherein the optical system has an optical axis and has anamorphic properties in a lateral direction and a transverse direction that are perpendicular to each other and perpendicular to the optical axis, wherein the spatial light modulator comprises pixels distributed in the lateral direction, and the optical system comprises: a transverse anamorphic component having positive optical power in the transverse direction, wherein the transverse anamorphic component is arranged to receive light from the spatial light modulator and the illumination system is arranged so that light output from the transverse anamorphic component is directed in directions that are distributed in the transverse direction; an extraction waveguide arranged to receive light from the transverse anamorphic component; a lateral anamorphic component having positive optical power in the lateral direction, the extraction waveguide being arranged to guide light from the transverse anamorphic component to the lateral anamorphic component along the extraction waveguide in a first direction; and a light reversing reflector that is arranged to reflect light that has been guided along the extraction waveguide in the first direction so that the reflected light is guided along the extraction waveguide in a second direction opposite to the first direction; wherein: the extraction waveguide comprises an array of extraction features, the extraction features being arranged to transmit light guided along the extraction waveguide in the first direction and to extract light guided along the extraction waveguide in the second direction such that the extracted light is output light that is directed towards the eye of the viewer, the array of extraction features being distributed along the extraction waveguide so as to provide exit pupil expansion; and the extraction features have tilts that vary along the extraction waveguide in the second direction such that the output light from each point of the spatial light modulator has vergence in the transverse direction and, when the output light is viewed by the eye of the viewer, the vergence allows the eye of the viewer to focus the output light from a finite viewing distance in the transverse direction.

A near-eye display may provide images to an observer so that their eye focusses at a finite viewing distance. Stereoscopic images may be provided for virtual images provided with image disparity suitable for finite viewing distance. Accommodation may be matched to image convergence and increased viewing comfort achieved. Correction for ophthalmic conditions such as myopia, hypertropia and presbyopia may be achieved for viewing of virtual images. A thin waveguide may be provided, reducing the bulk and weight of the near-eye display apparatus. A large exit pupil may be achieved to improve the freedom of movement of the eye and reduce image vignetting. A high-efficiency near-eye display apparatus for white light illumination may be provided with high image quality over large fields of view.

In the transverse direction, each extraction feature may be linear. The cost and complexity of fabrication of the array of extraction features may be reduced.

In the transverse direction, each extraction feature may be curved. Image blur may be reduced and image fidelity improved. In the transverse direction, each extraction feature may be curved with the same curvature. Cost and complexity of manufacture may be reduced.

In the transverse direction, each extraction feature may be curved with a curvature that changes along the extraction waveguide in the second direction. Uniformity of the virtual image may be improved and image blur reduced.

The vergence in the transverse direction may be divergence. The virtual image may be arranged behind the near-eye display apparatus and arranged to be around a typical viewing distance from the viewer. Well-corrected eyes and myopic eyes may be conveniently provided with sharp virtual images.

The lateral anamorphic component and the extraction features may be configured such that the output light from each point of the spatial light modulator has vergence in the lateral direction so that, when the output light is viewed by the eye of the viewer, the vergence of the output light allows the eye of the viewer to focus the output light from a finite viewing distance in the lateral direction. The vergence in the lateral direction may be divergence. The extraction features may be curved with negative optical power in the lateral direction to cause divergence in the lateral direction. The vergence in the lateral direction may be arranged to match the vergence in the transverse direction and a sharp image may be provided on the retina of a well-corrected eye. The vergence in the lateral direction may be arranged to be different to the vergence in the transverse direction. Correction for astigmatism of the eye may be provided and increased image sharpness may be achieved.

The lateral anamorphic component may be configured to cause divergence in the lateral direction. The extraction features may be linear in the lateral direction to cause no change of the vergence of the output light in the lateral direction. The cost and complexity of the extraction features may be reduced.

The extraction features may be curved with positive optical power in the lateral direction to reduce the divergence caused by the lateral anamorphic component in the lateral direction. Each extraction feature may be curved in the lateral direction with a curvature that changes along the extraction waveguide in the second direction. Aberrations may be reduced and increased fidelity of the perceived virtual image achieved across the exit pupil.

According to a second aspect of the present disclosure, there is provided an anamorphic near-eye display apparatus comprising: an illumination system comprising a spatial light modulator, the illumination system being arranged to output light; and an optical system arranged to direct light from the illumination system to an eye of a viewer, wherein the optical system has an optical axis and has anamorphic properties in a lateral direction and a transverse direction that are perpendicular to each other and perpendicular to the optical axis, wherein the spatial light modulator comprises pixels distributed in the lateral direction, and the optical system comprises: a transverse anamorphic component having positive optical power in the transverse direction, wherein the transverse anamorphic component is arranged to receive light from the spatial light modulator and the illumination system is arranged so that light output from the transverse anamorphic component is directed in directions that are distributed in the transverse direction; an extraction waveguide arranged to receive light from the transverse anamorphic component; a lateral anamorphic component having positive optical power in the lateral direction, the extraction waveguide being arranged to guide light from the transverse anamorphic component to the lateral anamorphic component along the extraction waveguide in a first direction; and a light reversing reflector that is arranged to reflect light that has been guided along the extraction waveguide in the first direction so that the reflected light is guided along the extraction waveguide in a second direction opposite to the first direction, wherein the extraction waveguide comprises an array of extraction features, the extraction features being arranged to pass light guided along the extraction waveguide in the first direction and to extract light guided along the extraction waveguide in the second direction such that the extracted light is output light that is directed towards the eye of the viewer, the array of extraction features being distributed along the extraction waveguide so as to provide exit pupil expansion; and wherein the lateral anamorphic component and the extraction features are configured such that the output light from each point of the spatial light modulator has vergence in the lateral direction so that, when the output light is viewed by the eye of the viewer, the vergence of the output light allows the eye of the viewer to focus the output light from a finite viewing distance in the lateral direction. The vergence in the lateral direction may be divergence. The lateral anamorphic component may be configured to cause divergence in the lateral direction. The extraction features may be curved with negative optical power in the lateral direction to cause divergence in the lateral direction. The extraction features may be linear in the lateral direction to cause no change of the vergence of the output light in the lateral direction. The extraction features may be curved with positive optical power in the lateral direction to reduce the divergence caused by the lateral anamorphic component in the lateral direction. The extraction features may be extraction features disposed internally within the extraction waveguide.

The extraction features may comprise extraction reflectors that extend across at least part of the extraction waveguide between front and rear guide surfaces of the extraction waveguide. The extraction waveguide may have a front guide surface and a rear guide surface, and the rear guide surface may comprise extraction surfaces that are the extraction features, each extraction surface being arranged to reflect light guided in the second direction towards an eye of a viewer through the front guide surface. Advantageously the cost and complexity of the waveguide may be reduced.

The extraction waveguide may have a front guide surface and a rear guide surface, and the rear guide surface may comprise a diffractive optical element comprising the extraction features. Advantageously the cost and complexity of the array of extraction features may be reduced.

According to a third aspect of the present disclosure, there is provided an anamorphic near-eye display apparatus, wherein: the extraction waveguide comprises: a front guide surface; a polarisation-sensitive reflector opposing the front guide surface; and an extraction element disposed outside the polarisation-sensitive reflector, the extraction element comprising: a rear guide surface opposing the front guide surface; and the array of extraction features; the anamorphic near-eye display apparatus is arranged to provide light guided along the extraction waveguide in the first direction with an input linear polarisation state before reaching the polarisation-sensitive reflector; and the optical system further comprises a polarisation conversion retarder disposed between the polarisation-sensitive reflector and the light reversing reflector, wherein the polarisation conversion retarder is arranged to convert a polarisation state of light passing therethrough between a linear polarisation state and a circular polarisation state, and the polarisation conversion retarder and the light reversing reflector are arranged in combination to rotate the input linear polarisation state of the light guided in the first direction so that the light guided in the second direction and output from the polarisation conversion retarder has an orthogonal linear polarisation state that is orthogonal to the input linear polarisation state; the polarisation-sensitive reflector is arranged to reflect light guided in the first direction having the input linear polarisation state and to pass light guided in the second direction having the orthogonal linear polarisation state, so that the front guide surface and the polarisation-sensitive reflector are arranged to guide light in the first direction, and the front guide surface and the rear guide surface are arranged to guide light in the second direction; and the array of extraction features is arranged to extract light guided along the extraction waveguide in the second direction towards an eye of a viewer through the front guide surface, the array of extraction features being distributed along the extraction waveguide so as to provide exit pupil expansion in the transverse direction. The polarisation-sensitive reflector may comprise at least one of a reflective linear polariser, a liquid crystal layer or a dichroic stack.

Advantageously stray light and losses for light propagating in the first direction along the waveguide are reduced. High efficiency may be achieved for white light illumination.

According to a fourth aspect of the present disclosure, there is provided a head-worn display apparatus comprising an anamorphic near-eye display apparatus and a head-mounting arrangement arranged to mount the anamorphic near-eye display apparatus on a head of a wearer with the anamorphic near-eye display apparatus extending across at least one eye of the wearer. Virtual Reality (VR) and Augmented Reality (AR) images may be conveniently provided to moving observers.

Any of the aspects of the present disclosure may be applied in any combination.

Embodiments of the present disclosure may be used in a variety of optical systems. The embodiments may include or work with a variety of projectors, projection systems, optical components, displays, microdisplays, computer systems, processors, self-contained projector systems, visual and/or audio-visual systems and electrical and/or optical devices. Aspects of the present disclosure may be used with practically any apparatus related to optical and electrical devices, optical systems, presentation systems or any apparatus that may contain any type of optical system. Accordingly, embodiments of the present disclosure may be employed in optical systems, devices used in visual and/or optical presentations, visual peripherals and so on and in a number of computing environments and automotive environments.

Before proceeding to the disclosed embodiments in detail, it should be understood that the disclosure is not limited in its application or creation to the details of the particular arrangements shown, because the disclosure is capable of other embodiments. Moreover, aspects of the disclosure may be set forth in different combinations and arrangements to define embodiments unique in their own right. Also, the terminology used herein is for the purpose of description and not of limitation.

These and other advantages and features of the present disclosure will become apparent to those of ordinary skill in the art upon reading this disclosure in its entirety.

### BRIEF DESCRIPTION OF THE DRAWINGS

Embodiments are illustrated by way of example in the accompanying FIGURES, in which like reference numbers indicate similar parts, and in which:

FIG. 1A is a schematic diagram illustrating a rear perspective view of an anamorphic near-eye display apparatus (ANEDA) arranged to provide visibility of an external real object and to provide a virtual image at a finite viewing distance wherein an optical waveguide comprises light extraction features that extend through the optical waveguide;

FIG. 1B is a schematic diagram illustrating a rear perspective view of light ray propagation in the ANEDA of FIG. 1A;

FIG. 1C is a schematic diagram illustrating a rear perspective view of virtual image formation from the ANEDA of FIGS. 1A-B;

FIG. 1D is a schematic diagram illustrating a rear perspective view of real image formation through the ANEDA of FIGS. 1A-B;

FIG. 2 is a schematic diagram illustrating a side view of light output from the ANEDA of FIG. 1B to provide a virtual image at a finite viewing distance in the transverse direction;

FIG. 3A is a schematic diagram illustrating a side view of light output from the ANEDA of FIG. 2 to provide a virtual image at a finite viewing distance in the transverse direction;

FIG. 3B is a schematic diagram illustrating a side view of the construction of the extraction reflectors of FIG. 1A to provide a virtual image at a finite viewing distance in the transverse direction;

FIG. 3C is a schematic diagram illustrating a front perspective view of light output from an alternative arrangement of an ANEDA arranged to provide a virtual image at a finite viewing distance;

FIG. 3D are schematic diagrams illustrating in side perspective views a method to form the optical waveguide of FIG. 2;

FIG. 4A is a schematic diagram illustrating a front perspective view of an ANEDA comprising extraction features that are curved with negative optical power in the lateral direction that is the same across the array of extraction features;

FIG. 4B is a schematic diagram illustrating a front perspective view of an ANEDA comprising extraction features that are straight in the lateral direction and the shape of the lateral anamorphic component is provided with additional negative optical power;

FIG. 4C is a schematic diagram illustrating a front perspective view of an ANEDA comprising extraction features that are curved in the lateral direction with negative optical power that varies across the array of extraction features;

FIG. 4D is a schematic diagram illustrating a front perspective view of an ANEDA comprising extraction features that are curved with positive optical power in the lateral direction and the shape of the lateral anamorphic component is provided with additional negative optical power;

FIG. 5A is a schematic diagram illustrating a rear perspective view of an ANEDA further comprising a corrective lens to compensate for ophthalmic conditions of the eye of the viewer;

FIG. 5B is a schematic diagram illustrating in side and top views light output from an ANEDA not comprising the curved light extraction features of the type of FIG. 1A;

FIG. 5C is a schematic diagram illustrating in side and top views light output from an ANEDA of the type of FIG. 1A;

FIG. 5D is a schematic diagram illustrating in side and top views light output from an ANEDA of the type of FIG. 1A and further arranged to provide vision correction for the hyperopic eye of a viewer;

FIG. 5E is a schematic diagram illustrating in side and top views light output from an ANEDA of the type of FIG. 1A and further arranged to provide vision correction for the myopic astigmatic eye of a viewer;

FIG. 5F is a schematic diagram illustrating in side view operation of a diverging corrective lens for a myopic eye;

FIG. 5G is a schematic diagram illustrating in side view operation of the arrangement of FIG. 5G wherein the virtual image is arranged for an infinite conjugate distance;

FIG. 5H is a schematic diagram illustrating in side view operation of the arrangement of FIG. 5G wherein the virtual image is arranged for a finite conjugate distance;

FIG. 6A is a schematic diagram illustrating a rear perspective view of an alternative ANEDA arranged to provide a virtual image at a finite viewing distance wherein the optical waveguide comprises light extraction features that are stepped in an array through the optical waveguide;

FIG. 6B is a schematic diagram illustrating a rear perspective view of an alternative ANEDA arranged to provide a virtual image at a finite viewing distance wherein the optical waveguide comprises light extraction features that are provided as steps on the rear surface of the waveguide;

FIG. 7A is a schematic diagram illustrating a rear perspective view of an alternative ANEDA arranged to provide a virtual image at a finite viewing distance wherein the optical waveguide comprises light extraction features that are provided as steps on the rear surface of the waveguide and outside a polarisation-sensitive reflector;

FIG. 7B is a schematic diagram illustrating a side view of the operation of the ANEDA of FIG. 7A;

FIG. 7C is a schematic diagram illustrating a rear perspective view of an alternative ANEDA arranged to provide a virtual image at a finite viewing distance wherein the optical waveguide comprises alternative light extraction features that are provided on the front surface of the waveguide and outside the polarisation-sensitive reflector;

FIG. 7D is a schematic diagram illustrating a side view of light extraction and light transmission by the anamorphic near-eye display apparatus of FIG. 7C;

FIG. 7E is a schematic diagram illustrating a rear perspective view of an alternative ANEDA arranged to provide a virtual image at a finite viewing distance wherein the optical waveguide comprises light extraction features that are provided on the front surface of the waveguide and outside a polarisation-sensitive reflector;

FIG. 7F is a schematic diagram illustrating a side view of the operation of the ANEDA of FIG. 7E;

FIG. 8A is a schematic diagram illustrating a rear perspective view of an alternative ANEDA arranged to provide a virtual image at a finite viewing distance wherein the optical waveguide comprises diffractive light extraction features outside a polarisation-sensitive reflector;

FIG. 8B is a schematic diagram illustrating a side view of the operation of the ANEDA of FIG. 8A;

FIG. 9A is a schematic diagram illustrating a side view of a transverse exit pupil provided by a single transverse anamorphic component comprising a lens stack;

FIG. 9B is a schematic diagram illustrating a side view of exit pupil expansion in the transverse direction of the ANEDA of FIG. 1A;

FIG. 9C is a schematic diagram illustrating a front perspective view of the lateral exit pupil provided by the lateral anamorphic component comprising a light reversing reflector;

FIG. 10A, FIG. 10B, and FIG. 10C are schematic diagrams illustrating in front views arrangements of anamorphic pixels of a spatial light modulator for use in the ANEDA of FIG. 1A and comprising spatially multiplexed red, green and blue sub-pixels;

FIG. 10D is a schematic diagram illustrating in front view an arrangement of anamorphic pixels of a spatial light modulator for use in the ANEDA of FIG. 1A wherein the red sub-pixels are larger than the green and blue sub-pixels;

FIG. 11 is a schematic diagram illustrating a top view of a stereoscopic ANEDA display device incorporating front views of virtual images arranged to provide a stereoscopic virtual image at a finite viewing distance;

FIG. 12A is a schematic diagram illustrating a rear perspective view of an alternative ANEDA arranged to provide first and second virtual images at finite viewing distances and further comprises two different ANEDAs arranged in series;

FIG. 12B is a schematic diagram illustrating a side view of the operation of the arrangement of FIG. 12A;

FIG. 13A is a schematic diagram illustrating a rear perspective view of an alternative near-eye display apparatus arranged to provide first and second virtual images at finite viewing distances and comprising a non-anamorphic display apparatus and an ANEDA arranged in series;

FIG. 13B is a schematic diagram illustrating a side view of the operation of the arrangement of FIG. 13A;

FIG. 14A is a schematic diagram illustrating a side view of the operation of an alternative arrangement of a near-eye display apparatus comprising an ANEDA arranged to receive light from a non-ANEDA comprising a Fresnel lens and clean-up polariser;

FIG. 14B is a schematic diagram illustrating a side view of the operation of an alternative arrangement of a near-eye display apparatus comprising an ANEDA arranged to receive light from a non-ANEDA comprising a Pancake lens;

FIG. 15 is a schematic diagram illustrating in side view an alternative near-eye display apparatus further comprising Pancharatnam-Berry lenses arranged to provide adjustable focal distances for virtual images from an ANEDA;

FIG. 16A is a schematic diagram illustrating in rear perspective view an AR head-worn display apparatus comprising a right-eye anamorphic display apparatus arranged with a SLM in brow position;

FIG. 16B is a schematic diagram illustrating in rear perspective view an AR head-worn display apparatus comprising left-eye and right-eye anamorphic display apparatuses arranged with a SLM in brow position;

FIG. 16C is a schematic diagram illustrating in rear perspective view an eyepiece arrangement for an AR head-worn display apparatus;

FIG. 17A is a schematic diagram illustrating a rear view of a head-worn display apparatus comprising a left-eye near-eye display apparatus and a right-eye near-eye display apparatus and a head-mounting arrangement; and

FIG. 17B is a schematic diagram illustrating a rear view of a head-worn display apparatus comprising a left-eye near-eye display apparatus and a right-eye near-eye display apparatus and a head-mounting arrangement wherein the right-eye near-eye display apparatus transmits light from external scenes.

### DETAILED DESCRIPTION

Terms related to optical retarders for the purposes of the present disclosure will now be described.

In a layer comprising a uniaxial birefringent material there is a direction governing the optical anisotropy whereas all directions perpendicular to it (or at a given angle to it) have equivalent birefringence.

The optical axis of an optical retarder refers to the direction of propagation of a light ray in the uniaxial birefringent material in which no birefringence is experienced. This is different from the optical axis of an optical system which may for example be parallel to a line of symmetry or normal to a display surface along which a principal ray propagates.

For light propagating in a direction orthogonal to the optical axis, the optical axis is the slow axis when linearly polarized light with an electric vector direction parallel to the slow axis travels at the slowest speed. The slow axis direction is the direction with the highest refractive index at the design wavelength. Similarly the fast axis direction is the direction with the lowest refractive index at the design wavelength.

For positive dielectric anisotropy uniaxial birefringent materials the slow axis direction is the extraordinary axis of the birefringent material. For negative dielectric anisotropy uniaxial birefringent materials the fast axis direction is the extraordinary axis of the birefringent material.

The terms half a wavelength and quarter a wavelength refer to the operation of a retarder for a design wavelength λ₀ that may typically be between 500 nm and 570 nm. In the present illustrative embodiments exemplary retardance values are provided for a wavelength of 550 nm unless otherwise specified.

The retarder provides a phase shift between two perpendicular polarization components of the light wave incident thereon and is characterized by the amount of relative phase, Γ, that it imparts on the two polarization components: which is related to the birefringence Δn and the thickness d of the retarder with retardance Δn·d by:

$$Γ = 2 \cdot π \cdot Δ n \cdot d / {λ}_{0} \qquad eqn . 1$$

In eqn. 1, Δn is defined as the difference between the extraordinary and the ordinary index of refraction, i.e.

$$Δ n = {n}_{e} - {n}_{o} \qquad eqn . 2$$

For a half-wave retarder, the relationship between d, Δn, and λ₀ is chosen so that the phase shift between polarization components is Γ=π. For a quarter-wave retarder, the relationship between d, Δn, and λ₀ is chosen so that the phase shift between polarization components is Γ=π/2.

Some aspects of the propagation of light rays through a transparent retarder between a pair of polarisers will now be described.

The state of polarisation (SOP) of a light ray is described by the relative amplitude and phase shift between any two orthogonal polarization components. Transparent retarders do not alter the relative amplitudes of these orthogonal polarisation components but act only on their relative phase. Providing a net phase shift between the orthogonal polarisation components alters the SOP whereas maintaining net relative phase preserves the SOP. In the current description, the SOP may be termed the polarisation state.

A linear SOP has a polarisation component with a non-zero amplitude and an orthogonal polarisation component which has zero amplitude. A p-polarisation state is a linear polarisation state that lies within the plane of incidence of a ray comprising the p-polarisation state and a s-polarisation state is a linear polarisation state that lies orthogonal to the plane of incidence of a ray comprising the p-polarisation state. For a linearly polarised SOP incident onto a retarder, the relative phase Γ is determined by the angle between the optical axis of the retarder and the direction of the polarisation component.

A linear polariser transmits a unique linear SOP that has a linear polarisation component parallel to the electric vector transmission direction of the linear polariser and attenuates light with a different SOP. The term “electric vector transmission direction” refers to a non-directional axis of the polariser parallel to which the electric vector of incident light is transmitted, even though the transmitted “electric vector” always has an instantaneous direction. The term “direction” is commonly used to describe this axis.

Absorbing polarisers are polarisers that absorb one polarisation component of incident light and transmit a second orthogonal polarisation component. Examples of absorbing linear polarisers are dichroic polarisers.

Reflective polarisers are polarisers that reflect one polarisation component of incident light and transmit a second orthogonal polarisation component. Examples of reflective polarisers that are linear polarisers are multilayer polymeric film stacks such as DBEF™ or APF™ from 3M Corporation, or wire grid polarisers such as ProFlux™ from Moxtek. Reflective linear polarisers may further comprise cholesteric reflective materials and a quarter-wave retarder arranged in series.

A retarder arranged between a linear polariser and a parallel linear analysing polariser that introduces no relative net phase shift provides full transmission of the light other than residual absorption within the linear polariser.

A retarder that provides a relative net phase shift between orthogonal polarisation components changes the SOP and provides attenuation at the analysing polariser.

Achromatic retarders may be provided wherein the material of the retarder is provided with a retardance Δn·d that varies with wavelength λ as

$$Δ n \cdot d / λ = κ \qquad eqn . 3$$

where κ is substantially a constant.

Examples of suitable materials include modified polycarbonates from Teijin Films. Achromatic retarders may be provided in the present embodiments to advantageously minimise colour changes between polar angular viewing directions which have low luminance reduction and polar angular viewing directions which have increased luminance reductions as will be described below.

Various other terms used in the present disclosure related to retarders and to liquid crystals will now be described.

A liquid crystal cell has a retardance given by Δn·d where Δn is the birefringence of the liquid crystal material in the liquid crystal cell and d is the thickness of the liquid crystal cell, independent of the alignment of the liquid crystal material in the liquid crystal cell.

Homogeneous alignment refers to the alignment of liquid crystals in switchable liquid crystal displays where molecules align substantially parallel to a substrate. Homogeneous alignment is sometimes referred to as planar alignment. Homogeneous alignment may typically be provided with a small pre-tilt such as 2 degrees, so that the molecules at the surfaces of the alignment layers of the liquid crystal cell are slightly inclined as will be described below. Pretilt is arranged to minimise degeneracies in switching of cells.

In the present disclosure, homeotropic alignment is the state in which rod-like liquid crystalline molecules align substantially perpendicularly to the substrate. In discotic liquid crystals homeotropic alignment is defined as the state in which an axis of the column structure, which is formed by disc-like liquid crystalline molecules, aligns perpendicularly to a surface. In homeotropic alignment, pretilt is the tilt angle of the molecules that are close to the alignment layer and is typically close to 90 degrees and for example may be 88 degrees.

In a twisted liquid crystal layer, a twisted configuration (also known as a helical structure or helix) of nematic liquid crystal molecules is provided. The twist may be achieved by means of a non-parallel alignment of alignment layers. Further, cholesteric dopants may be added to the liquid crystal material to break degeneracy of the twist direction (clockwise or anti-clockwise) and to further control the pitch of the twist in the relaxed (typically undriven) state. A supertwisted liquid crystal layer has a twist of greater than 180 degrees. A twisted nematic layer used in spatial light modulators typically has a twist of 90 degrees.

Liquid crystal molecules with positive dielectric anisotropy are switched from a homogeneous alignment (such as an A-plate retarder orientation) to a homeotropic alignment (such as a C-plate or O-plate retarder orientation) by means of an applied electric field.

Liquid crystal molecules with negative dielectric anisotropy are switched from a homeotropic alignment (such as a C-plate or O-plate retarder orientation) to a homogeneous alignment (such as an A-plate retarder orientation) by means of an applied electric field.

Rod-like molecules have a positive birefringence so that nₑ>nₒ as described in eqn. 2. Discotic molecules have negative birefringence so that nₑ<nₒ.

Positive retarders such as A-plates, positive O-plates and positive C-plates may typically be provided by stretched films or rod-like liquid crystal molecules. Negative retarders such as negative C-plates may be provided by stretched films or discotic-like liquid crystal molecules.

Parallel liquid crystal cell alignment refers to the alignment direction of homogeneous alignment layers being parallel or more typically antiparallel. In the case of pre-tilted homeotropic alignment, the alignment layers may have components that are substantially parallel or antiparallel. Hybrid aligned liquid crystal cells may have one homogeneous alignment layer and one homeotropic alignment layer. Twisted liquid crystal cells may be provided by alignment layers that do not have parallel alignment, for example oriented at 90 degrees to each other.

The structure and operation of various near-eye display apparatuses will now be described. In this description, common elements have common reference numerals. It is noted that the disclosure relating to any element applies mutatis mutandi to each device in which the same or corresponding element is provided. Accordingly, for brevity such disclosure is not repeated. Similarly, the various features of any of the following examples may be combined together in any combination.

It would be desirable to provide a near-eye display apparatus 100 with a thin form factor, large freedom of movement, high resolution, high brightness and wide field of view. It would further be desirable to provide a finite viewing distance for perceived virtual images.

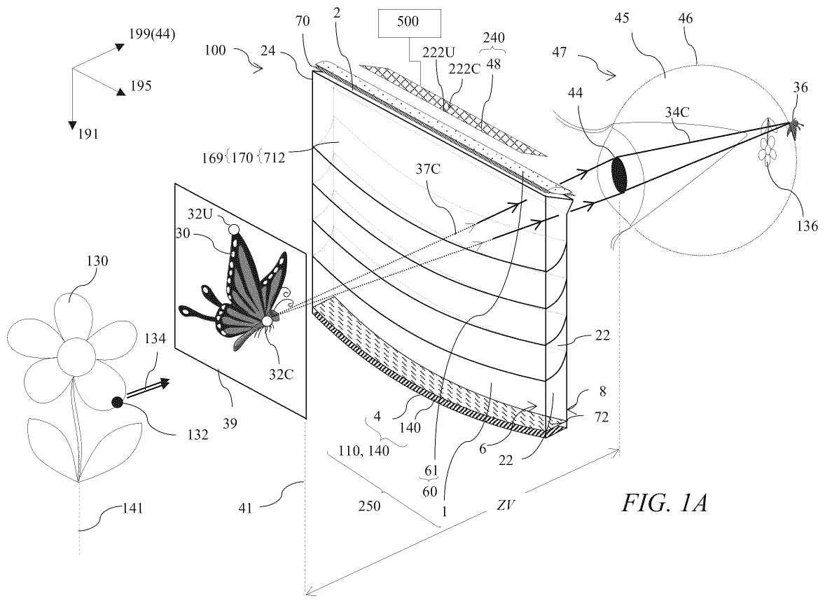

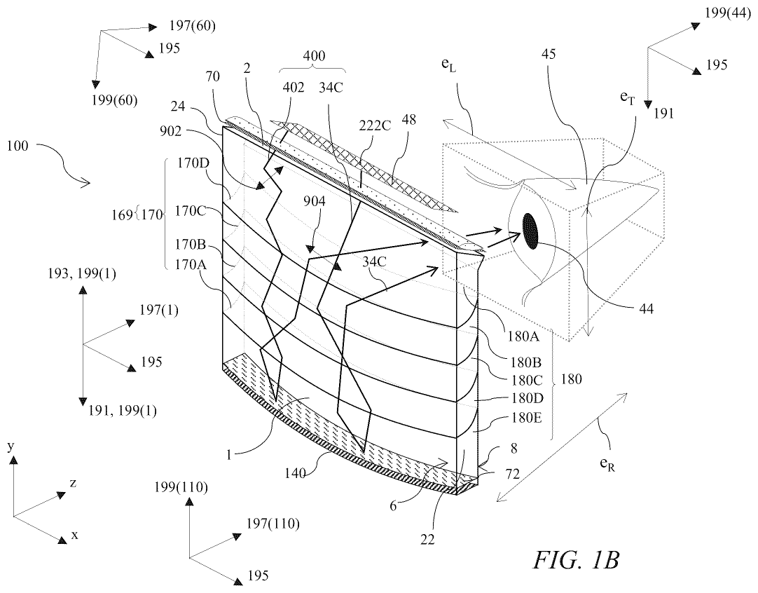

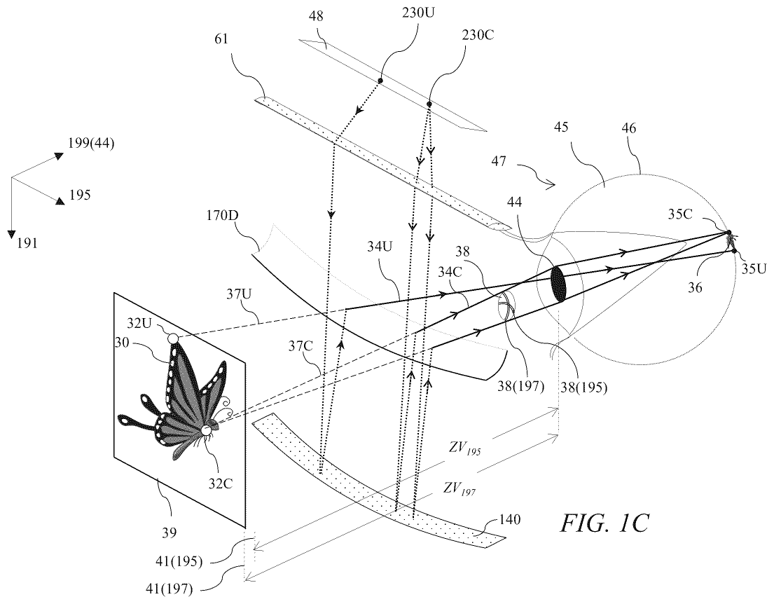

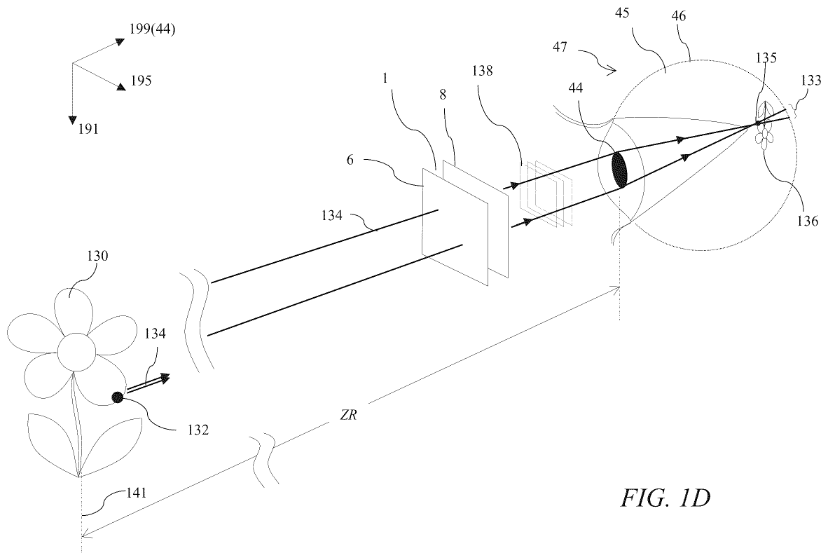

FIG. 1A is a schematic diagram illustrating a rear perspective view of an anamorphic near-eye display apparatus (ANEDA) 100 arranged to provide visibility of an external real object 130 in a plane 141 and to provide a virtual image 30 at a finite viewing distance ZV in a plane 41 wherein an optical waveguide 1 comprises light extraction features 169 that are extraction reflectors 170 that extend through the optical waveguide 1.

The ANEDA 100 comprises: an illumination system 240 comprising a spatial light modulator (SLM) 48, the illumination system 240 being arranged to output light. Optical system 250 is arranged to direct light from the illumination system 240 to an eye 45 of a viewer 47, to provide light to the pupil 44 of the eye 45 of a viewer 47.

In operation, it is desirable that the spatial pixel data provided on the SLM 48 is directed to the pupil 44 of the eye 45 as angular pixel data. The lens of the eye 45 of a viewer 47 relays the angular pixel data in rays 34C to spatial pixel data as image 36 at the retina 46 of the eye 45 as will be described further with reference to FIG. 1C hereinbelow. Similarly the eye 45 of the viewer 47 may receive light from an external real object 130 that may be in the real world and provides an image 136 within the eye 45 that in the embodiment of FIG. 1A and FIG. 1D hereinbelow is not focused onto the retina 46 in at least one focus condition of the eye 45.

The SLM 48 comprises pixels 222 distributed in the lateral direction 195 as will be described further hereinbelow, for example in FIGS. 10A-D. In the illustrative embodiment of FIG. 1A, the illumination system 240 comprises an emissive SLM 48 comprising an array of spatially separated pixels 222 distributed in a lateral direction 195 (48) and transverse direction 197 (48). In the embodiment of FIG. 1A, the SLM 48 is an OLED micro-display but may alternatively be provided by a TFT-LCD and the illumination system 240 further comprises a backlight 20 arranged to illuminate the SLM 48. In alternative embodiments, the illumination system may comprise laser light sources and scanning arrangements (not shown).

The ANEDA 100 further comprises a control system 500 arranged to operate the illumination system 240 to provide light that is spatially modulated in accordance with image data representing a virtual image 30 that is the intended virtual image within virtual field of view 39 arranged in a nominal virtual image plane 41.

The optical system 250 has an optical axis 199 and has anamorphic properties in a lateral direction 195 and in a transverse direction 197 that are perpendicular to each other and perpendicular to the optical axis 199.

Mathematically expressed, for any location within the ANEDA 100, the optical axis direction 199 may be referred to as the O unit vector, the transverse direction 197 may be referred to as the T unit vector and the lateral direction 195 may be referred to as the L unit vector wherein the optical axis direction 199 is the crossed product of the transverse direction 197 and the lateral direction 195:

$$O = T \times L \qquad eqn . 4$$

Various surfaces of the ANEDA 100 transform or replicate the optical axis direction 199; however, for any given ray, the expression of eqn. 4 may be applied.

The optical system 250 comprises a transverse anamorphic component 60 having positive optical power in the transverse direction 197 and comprising transverse lens 61 in the embodiment of FIG. 1A, as discussed below. The transverse lens 61 comprises a cylindrical lens in this example.

The transverse anamorphic component 60 is arranged to receive light rays 400 from the SLM 48. The illumination system 240 is arranged so that light output from the transverse anamorphic component 60 is directed in directions that are distributed in the transverse direction 197 (60).

In the embodiment of FIG. 1A, the transverse anamorphic component 60 is a transverse lens 61 that is extended in a lateral direction 195 (60) parallel to the lateral direction 195 (48) of the SLM 48. The transverse anamorphic component 60 that is lens 61 has positive optical power in a transverse direction 197 (60) that is parallel to the direction 197 (48) and orthogonal to the lateral direction 195 (60); and no optical power in the lateral direction 195 (60).

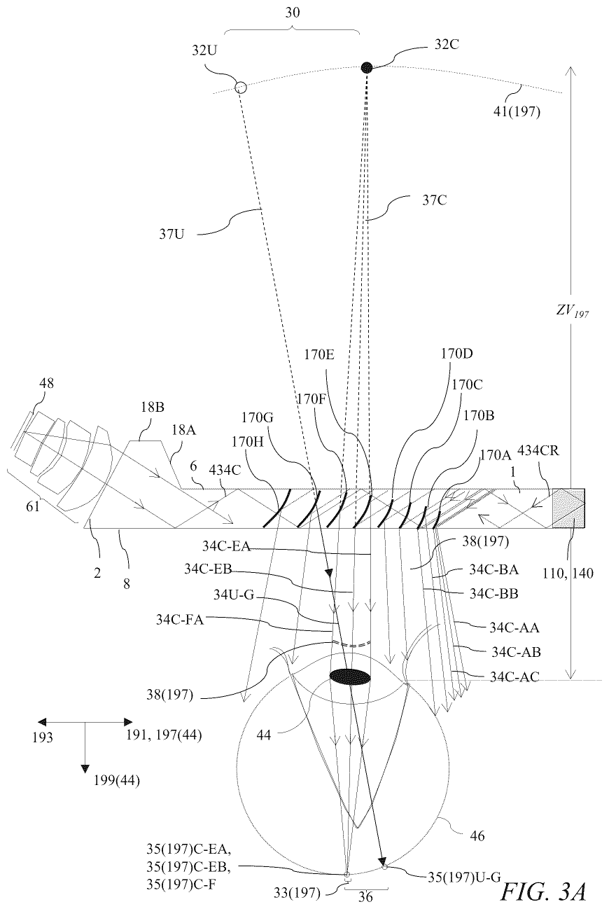

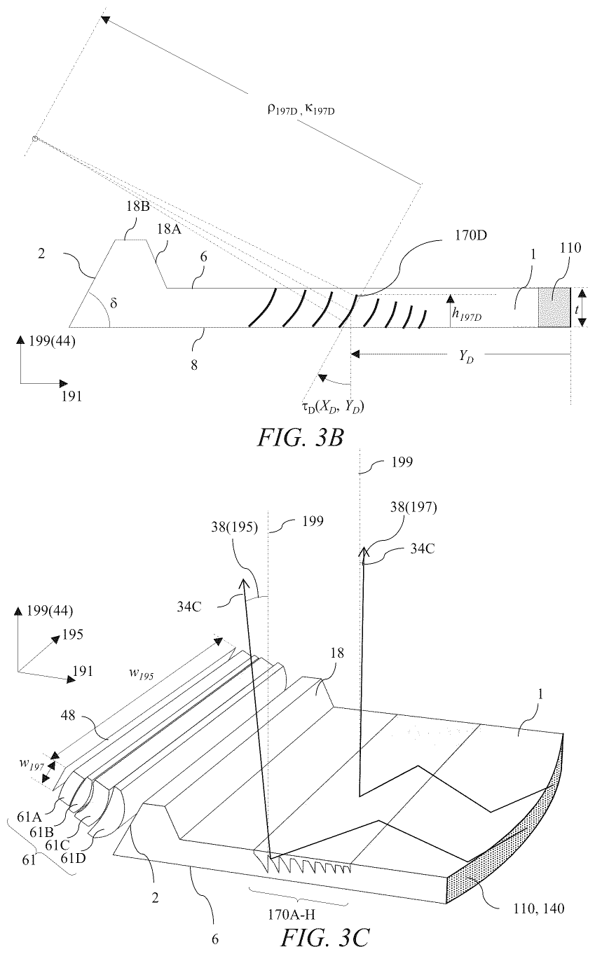

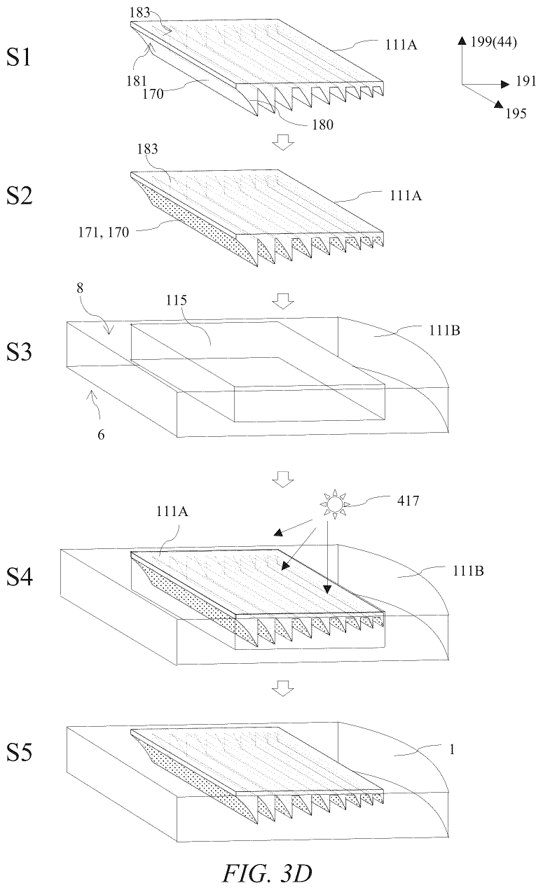

In the present disclosure, the term lens most generally refers to a single lens element or most commonly a compound lens (group of lens elements) as will be described hereinbelow in FIG. 3C for example; and is arranged to provide optical power. A lens may comprise a single refractive surface, multiple refractive surfaces, reflective surfaces or may comprise a catadioptric lens element that combines refractive and reflective surfaces. A lens may further or alternatively comprise diffractive optical elements.

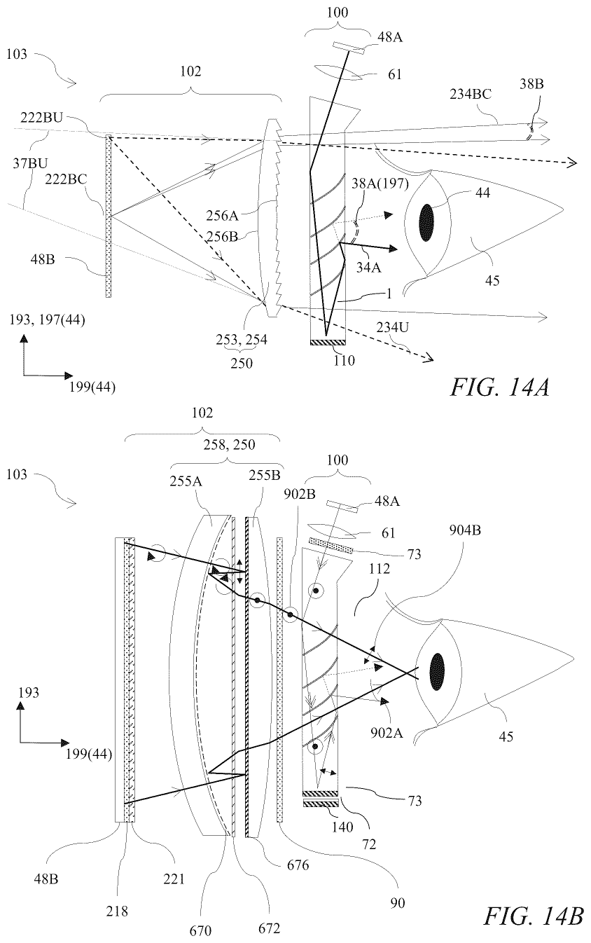

A transverse lens is a lens that provides optical power in the transverse direction. Typically a transverse lens provides no optical power in the lateral direction. A transverse lens may be termed a cylindrical lens, although the profile in cross section of the surface or surfaces providing optical power may be different to a segment of a circle, for example paraboidal, elliptical or aspheric. The transverse lens 61 may comprise a pancake lens, for example a cylindrical lens 650 of cross section similar to that illustrated for the rotationally symmetric lens of FIG. 14B hereinbelow. Advantageously aberrations in the transverse direction 197 may be improved and thickness reduced.

The optical system 250 further comprises an extraction waveguide 1 arranged to receive light from the transverse lens 61 and arranged to guide light rays 400 in cone 491 from the transverse lens 61 to a lateral anamorphic component 110 along the extraction waveguide 1 in a first direction 191. The lateral anamorphic component 110 has positive optical power in the lateral direction 195.

The extraction waveguide 1 further has an input end 2 extending in the lateral and transverse directions 195 (60), 197 (60), the extraction waveguide 1 being arranged to receive light 400 from the illumination system 240 through the input end 2. The input end 2 extends in the lateral direction 195 between edges 22, 24 of the extraction waveguide 1, and extends in the transverse direction between opposing surfaces of the extraction waveguide 1.

The optical system 250 further comprises a light reversing reflector 140 arranged to reflect the light rays 400 in light cones 491 that have been guided along the extraction waveguide 1 in the first direction 191. The reflected light is guided along the extraction waveguide 1 in a second direction 193 opposite to the first direction 191.

In the embodiment of FIG. 1A, the light reversing reflector 140 is a reflective end 4 of the extraction waveguide 1. Furthermore, the lateral anamorphic component 110 comprises the light reversing reflector 140. The reflective end 4 of the extraction waveguide 1 has a curved shape in the lateral direction 195 that provides positive optical power, affecting the light rays in cone 491 in the lateral direction 195 (110), and no power in the transverse direction 197 (110). The optical system 250 is thus arranged so that light output from the lateral anamorphic component 110 is directed in directions that are distributed in the transverse direction 197 (110) and the lateral direction 195 (110). The curved shape of the reflective end 4 may be a shape that is the cross section of a sphere, ellipse, parabola or other aspheric shape to achieve desirable imaging of light rays from the SLM 48 to the pupil 44 of the eye 45 as will be described further hereinbelow.

The extraction waveguide 1 comprises an array of extraction features 169, the extraction features 169 being arranged to transmit at least some of the light guided along the extraction waveguide 1 in the first direction 191 and to extract light guided along the extraction waveguide 1 in the second direction 193. The extracted light is output light that is directed towards an eye 45 of the viewer 47.

In the embodiment of FIG. 1A, the extraction features 169 are extraction reflectors 170 disposed internally within the extraction waveguide 1 and extend across the extraction waveguide 1 between front and rear guide surfaces 8, 6 of the extraction waveguide 1.

The propagation of light in the ANEDA 100 will now be further described.

FIG. 1B is a schematic diagram illustrating a rear perspective view of light ray 400 propagation in the ANEDA 100 of FIG. 1A. Features of the embodiment of FIG. 1B not discussed in further detail may be assumed to correspond to the features with equivalent reference numerals as discussed above, including any potential variations in the features.

The illumination system 240 is arranged to output light rays 400 including illustrative light rays 34C, 402 that are input into the optical system 250.

The pupil 44 of the eye 45 of the viewer 47 is located in a spatial volume near to the ANEDA 100 commonly referred to as the exit pupil 40, or eyebox. When the pupil 44 is located within the exit pupil 40, the viewer 47 is provided with a full image without missing parts of the image, that is the image does not appear to be vignetted at the retina 46 of the eye 45 of the viewer 47. The shape of the exit pupil 40 is determined at least by the anamorphic imaging properties of the ANEDA and the respective aberrations of the anamorphic optical system. The exit pupil 40 at a nominal eye relief distance e_{R} may have dimension CL in the lateral direction 195 and dimension e_{R} in the transverse direction 197. The maximum eye relief distance e_{R}_{ₘₐₓ} refers to the maximum distance of the pupil 44 from the ANEDA 100 wherein no image vignetting is present.

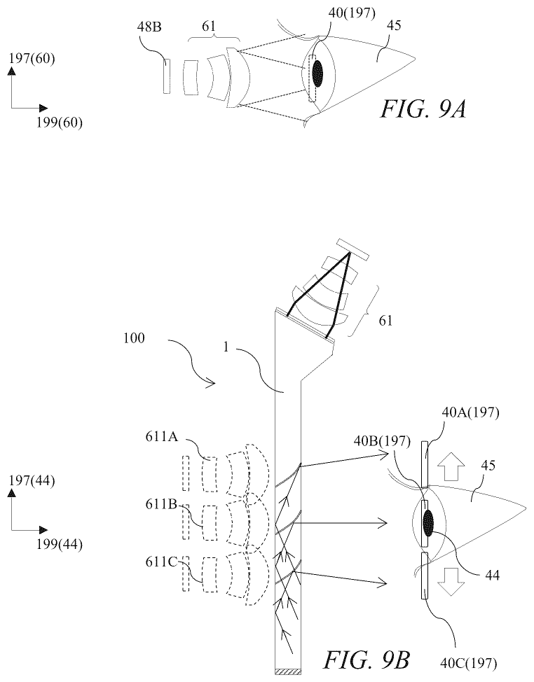

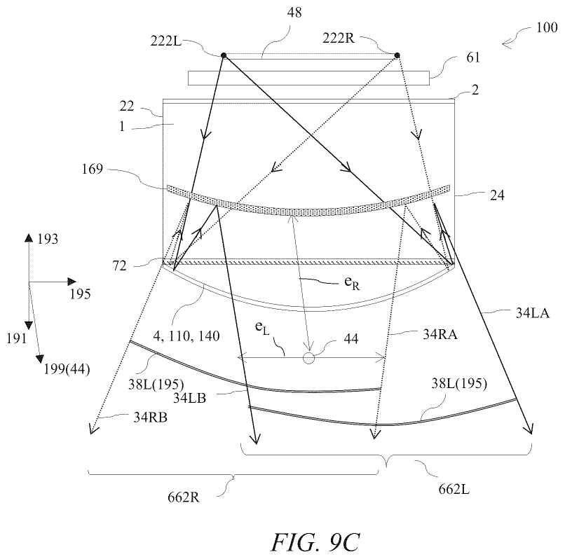

The array of extraction reflectors 170 is distributed along the extraction waveguide 1 so as to provide exit pupil 40 expansion. In the present embodiments, expanding the size of the exit pupil 40 refers to increasing the dimensions e_{L}, e_{T}. Increased exit pupil 40 achieves an increased viewer freedom and an increase in e_{R}_{ₘₐₓ} as will be described further hereinbelow with reference to FIGS. 9A-B for example.

In an illustrative embodiment, the eye 45 may be arranged at a nominal viewing distance e_{R} of between 5 mm and 100 mm and preferably between 8 mm and 25 mm from the output surface of the ANEDA 100. Such displays are distinct from direct view displays wherein the viewing distance is typically greater than 100 mm. The nominal viewing distance e_{R} may be referred to as the eye relief.

The principle of operation of the ANEDA 100 will now be further described.

FIG. 1B illustrates the variation of optical axis 199 direction, lateral direction 195 and transverse direction 197 as light rays propagate through the optical system 250. In the present description, the lateral and transverse directions 195, 197 are defined relative to the optical axis 199 direction in any part of the illumination system 240 or optical system 250, and are not in constant directions in space. In the embodiment of FIG. 1B, the transverse direction 197 (60) illustrates the transverse direction 197 at the transverse anamorphic component 60 formed by the transverse lens 61; the transverse direction 197 (110) illustrates the transverse direction 197 at the lateral anamorphic component 110; and the transverse direction 197 (44) illustrates the transverse direction 197 at the eye 45 of the viewer 47. The transverse anamorphic component 60 has lateral direction 195 (60) that is the same as the lateral direction 195 (110) of the lateral anamorphic component 110 and the lateral direction 195 (44) at the pupil 44 of the eye 45. The Euclidian coordinate system illustrated by x, y, z directions is invariant, whereas the transverse direction 197, lateral direction 195 and optical axis direction 199 may be transformed at various optical components, in particular by reflection from optical components, of the ANEDA 100.

Further features of the arrangement of FIG. 1A will now be described.

The optical system 250 may comprise an input linear polariser 70 disposed between the SLM 48 and the reflector plates 180 and disposed between the SLM 48 input end 2 of the extraction waveguide 1; and is arranged to pass light having the input linear polarisation state 902. In FIG. 1A, the input linear polariser 70 is arranged between the transverse anamorphic component 60 and the extraction waveguide 1. The input linear polariser 70 is an absorbing polariser such as a dichroic iodine polariser arranged to transmit a linear polarisation state 902 and absorb the orthogonal polarisation state 904. In alternative embodiments the linear polariser 70 may be arranged between the transverse anamorphic component 60 and the SLM 48 or may be the output polariser of the SLM 48.

In operation, extraction waveguide 1 is arranged to guide light rays 400 propagating in the first direction 191 between the rear and front guide surfaces 6, 8 as illustrated by the zig-zag paths of guided rays 34C, 402.

Waveguide 1 further comprises a reflective end 4 arranged to receive the guided light rays 34C. 402 from the input end 2. The lateral anamorphic component 110 comprises the reflective end 4 of the extraction waveguide 1 with a reflective material provided on the reflective end 4. The reflective material may be a reflective film such as ESR™ from 3M or may be an evaporated or sputtered metal material such as aluminium or silver. In the embodiment of FIGS. 1A-B, the lateral anamorphic component 110 is thus a curved mirror with positive optical power in the lateral direction 195 and no optical power in the transverse direction 197.

Further the optical system 250 may comprise a polarisation conversion retarder 72 disposed between the light reversing reflector 140 and the deflection arrangement 112 that may be an A-plate with an optical axis direction arranged to convert linearly polarised light to circularly polarised light and circularly polarised light to linearly polarised light such that polarisation state 904 is output in the second direction 193 from the polarisation conversion retarder 72. The operation of the input linear polariser 70 and polarisation conversion retarder 72 will be described further hereinbelow, for example in FIGS. 3A-B and FIGS. 10A-B.

For light rays 400 propagating in the second direction 193, the extraction waveguide is arranged to provide guiding between the rear and front guide surfaces 6, 8. Extraction reflectors 170A-D are provided between plates 180A-E of a stack of plates 180 and have the desirable reflectivity to p-polarisation state 902 and s-polarisation state 904 as illustrated in TABLE 1.

TABLE 1

| Item | Ray angle of incidence | Specification |
|---|---|---|
| s-polarisation 904 reflectivity | 50°-70° | >90% |
| p-polarisation 902 reflectivity | 50°-70° | <5% |
| s-polarisation 904 reflectivity | 0°-10° | <5% |
| p-polarisation 902 reflectivity | | |

One example of an extraction reflector 170 is a dichroic stack 712 as illustrated in TABLE 2 in the case that the extraction reflector 170 has a nominal tilt τ of 30° as illustrated in FIG. 3B hereinbelow.

TABLE 2

| | Illustrative | Refractive | Thickness |
|---|---|---|---|
| Item | material | index | (nm) |
| Plate 180 | PMMA | 1.50 | — |
| Dielectric layer | TiO₂ | 2.6 | 7 |
| Dielectric layer | SiO₂ | 1.5 | 79 |
| Dielectric layer | TiO₂ | 2.6 | 21 |
| Dielectric layer | SiO₂ | 1.5 | 30 |
| Dielectric layer | TiO₂ | 2.6 | 45 |

Other types of extraction reflectors 170 may be for example reflective linear polarisers.

For a light cone with polarisation state 904 propagating in the second direction 193, the extraction reflectors 170A-D are oriented to extract light guided back along the extraction waveguide 1 in the second direction 193 through the front guide surface 8 and towards the pupil 44 of eye 45 arranged in eyebox 40.

The operation of the ANEDA 100 as an AR display will now be further described.

The extraction waveguide 1 is transmissive to light, for example at least some light with polarisation state 902, such that on-axis real image point 132 on a real-world object 130 is directly viewed through the extraction waveguide 1 by light rays 134. Similarly virtual image 30 with aligned on-axis virtual pixel 32C is desirably viewed with virtual rays 37C. Such virtual rays 37C are provided by light rays 34C after reflection from extraction reflector 170A to the pupil 44 of eye 45. An AR display with high transmission of external light rays 134 may be provided.

Retinal image formation 36 will now be further described.

FIG. 1C is a schematic diagram illustrating a rear perspective view of virtual image 36 formation from the ANEDA 100 of FIGS. 1A-B; and FIG. 1D is a schematic diagram illustrating a rear perspective view of real image 136 formation through the ANEDA 100 of FIGS. 1A-B. Features of the embodiments of FIGS. 1C-D not discussed in further detail may be assumed to correspond to the features with equivalent reference numerals as discussed above, including any potential variations in the features.

FIG. 1A and FIG. 1C further illustrate the virtual image 30 comprising a central virtual image point 32C provided by the imaging of a point 230C of a pixel 222C of the SLM 48, and an upper virtual image point 32U provided by the imaging of a point 230U of a pixel 222U of the SLM 48. In the present embodiments, the pixel 222 and optical system 250 provides output light that has an angular cone of size ϕ corresponding to the angular light cone from across a pixel 222. By comparison, the vergence 38 of the present embodiments is an angular cone of finite size that is provided for each point 230 on the spatial light modulator 48.

When the output light 34 from a point 230 is viewed by the eye 45 of a viewer 47, the vergence 38 of the output light 34 allows the eye 45 of the viewer 47 to focus the output light 34 from a finite viewing distance ZV, with the virtual image point 32 provided at the distance ZV.

In order to focus on the virtual image 30 that appears to be at the finite viewing distance ZV, the human visual system (HVS) adopts a focal condition such that an image 36 with central and upper image points 35C. 35U (being relayed images of the points 230C, 230U on the spatial light modulator 48) are provided at the retina 46. The focal condition may be achieved for example by adjustment of the lens of the eye 45 by the HVS.

Output light rays 34C and corresponding virtual light rays 37C; and output light rays 34U with corresponding virtual light rays 37U are provided in ray bundles with divergence 38, wherein the divergence 38 represents a solid angle and may be measured as the steradians subtended for a 1 mm pupil diameter. Within the eye 45, said light rays 34C. 34U are focused to provide image point 35C. 35U. In an illustrative embodiment, the viewing distance ZV may be 2 metres so the divergence 38 has a solid angle of 0.2 microsteradians for the 1 mm pupil diameter.

The present embodiments achieve the divergence 38 of rays 34C, 34U from points 230C, 230U and virtual image points 32C, 32U such that a finite viewing distance ZV for virtual images 30 may be provided by the ANEDA 100. The divergence 38 may comprise the lateral divergence 38 (195) and the transverse divergence 38 (197) may alternatively be measured in degrees across a 1 mm diameter pupil. In the illustrative example, the lateral and transverse divergences 38 (195), 38 (197) are each desirably 0.029°.

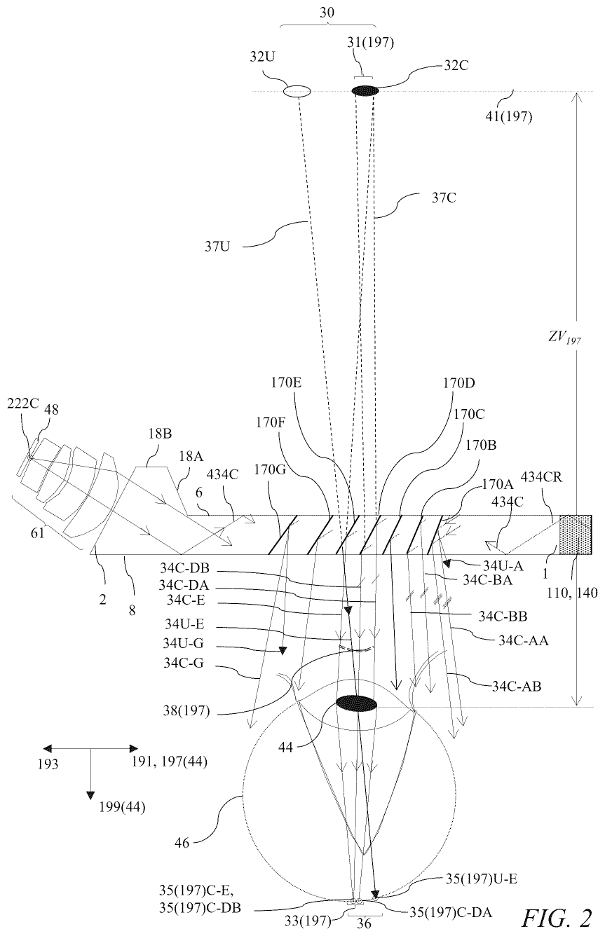

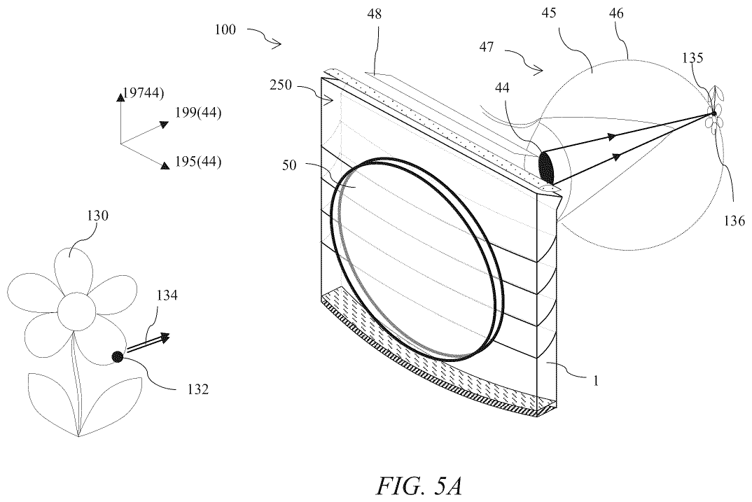

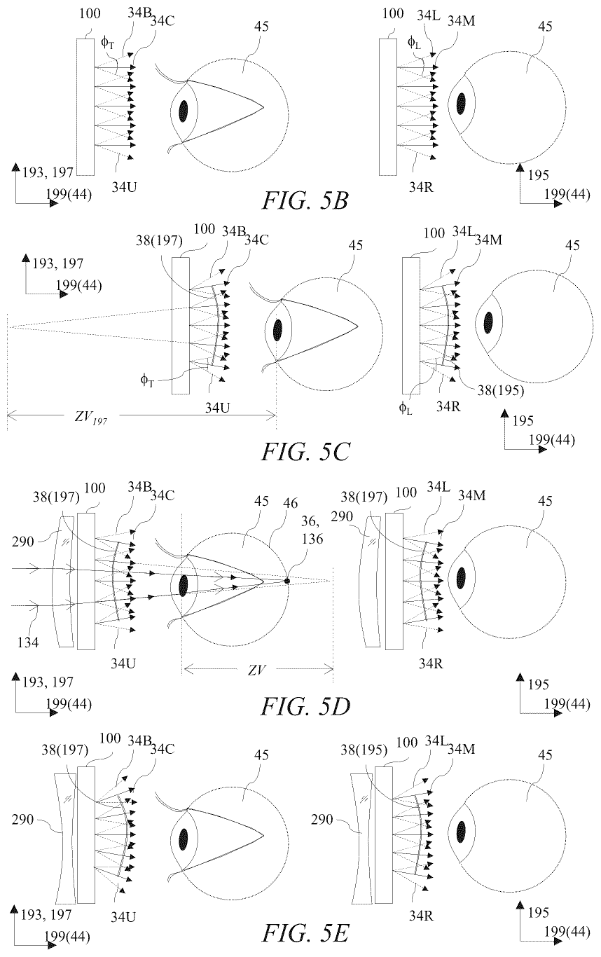

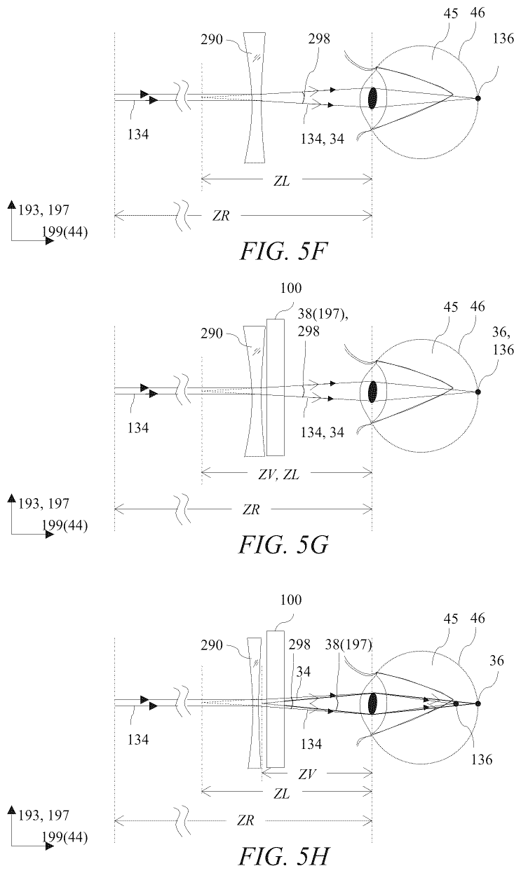

As will be further described with reference to FIG. 2 hereinbelow for example, the extraction features 169 have tilts τ that vary along the extraction waveguide 1 in the second direction 193 such that the output light 34 from each point 230 of the spatial light modulator 48 has vergence 38 (197) in the transverse direction 197. In FIG. 1C the vergence 38 in the transverse direction 197 is divergence. In alternative embodiments such as illustrated in FIG. 5D hereinbelow, the vergence 38 may be convergence.

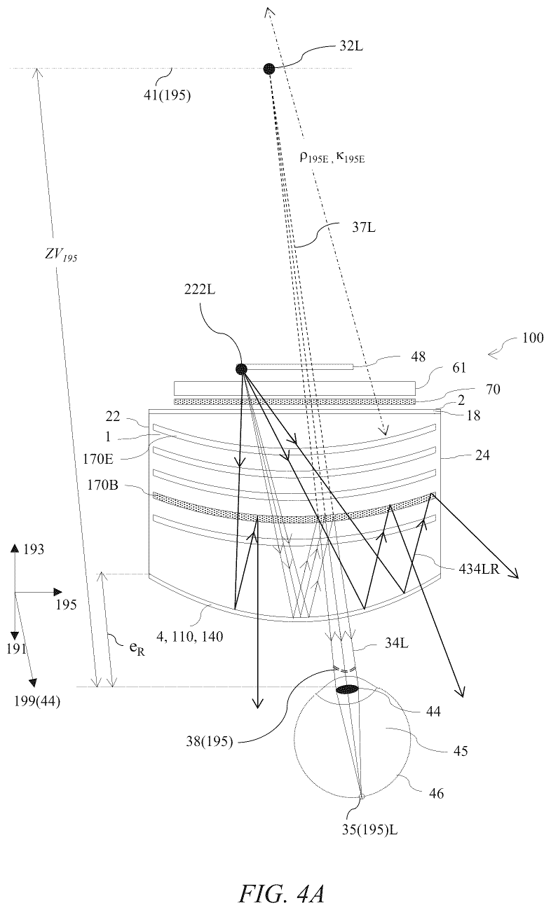

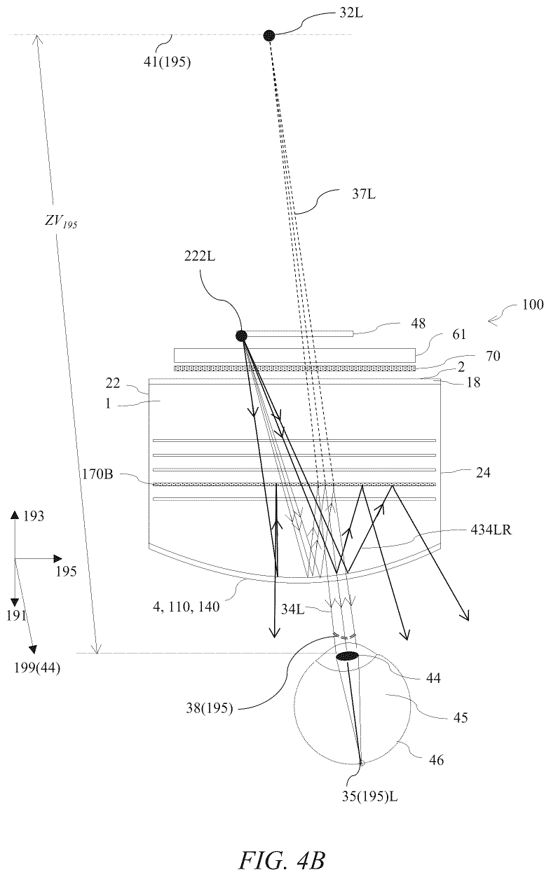

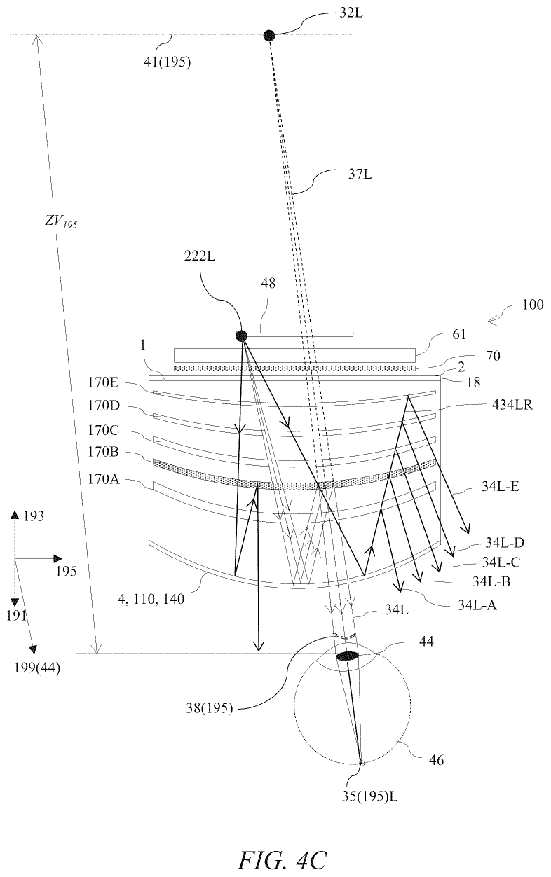

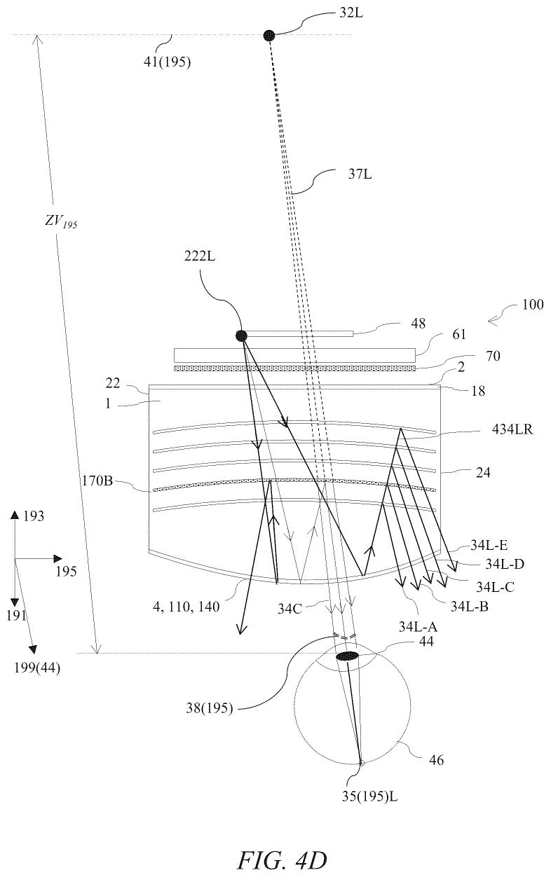

As will be described with reference to FIG. 4A hereinbelow for example, the extraction features 169 and/or the lateral anamorphic component 110 are arranged to provide divergence 38 (195) in the lateral direction 195. Said transverse divergence 38 (197) and lateral divergence 38 (195) provide divergence 38 from the point 230C and corresponding virtual image point 32C. The visual system of the viewer 47 then provides the perception of the virtual image point 32C at a finite viewing distance ZV₁₉₇ in the transverse direction 197 and finite viewing distance ZV₁₉₅ in the lateral direction 195. For non-astigmatic virtual images 30 the divergences 38 (195), 38 (197) and respective viewing distances ZV₁₉₇, ZV₁₉₅ are the same or similar.

FIG. 1A and FIG. 1D further illustrate that the extraction waveguide 1 further transmits light rays from external object 130 that in FIG. 1D is illustrated as at infinity so that rays 134 from point 132 are substantially parallel and wavefronts 138 representing substantially zero divergence are incident onto the pupil 44.

In the focal condition of the eye 45 of FIG. 1C to provide virtual image 36 at the retina 46 then the image 136 of the object 130 is imaged within the eye 45 and is out-of-focus on the retina to provide a blur region 133 at the retina 46. In a different focal condition of the eye 45, the image 136 may be focused onto the retina 46, and the image 36 is provided as an out-of-focus image at the retina 46 with blur 33 (not shown). In the case that the object 130 is provided at the distance ZV then both images 36, 136 are provided in focus at the retina 46 for the appropriate focal condition of the eye 45.

An arrangement of the extraction reflectors 170 to achieve divergence 38 (197) will now be described.

FIG. 2 is a schematic diagram illustrating a side view of light output from the ANEDA 100 of FIG. 1B to provide a virtual image 30 at a finite viewing distance ZV₁₉₇ in the transverse direction 197. Features of the embodiment of FIG. 2 not discussed in further detail may be assumed to correspond to the features with equivalent reference numerals as discussed above, including any potential variations in the features.

By way of comparison with FIG. 1A the alternative embodiment of FIG. 2 illustrates extraction features 169 that are extraction reflectors 170A-F wherein each extraction reflector is linear in the transverse direction 197. FIG. 2 further illustrates a transverse anamorphic component 60 comprising a compound lens 61 and further waveguide surfaces 18A, 18B arranged near the input end 2 of the waveguide 1.

FIG. 2 illustrates light rays 434C representing light from pixel 222C that propagates in first and second directions 191, 193 along the waveguide 1. Such light rays 434C are either parallel or are reflected about the rear or front light guide surfaces 6, 8 as light rays 434CR. Light rays 434CR are incident onto the extraction reflectors 170 and output through the front guide surface as light rays 34C. Illustrative light rays 34C include 34C-AA and 34C-AB output from different parts of the extraction reflector 170A; light rays 34C-BA and 34C-BB from extraction reflector 170B; light rays 34C-EA, 34C-EB from extraction reflector 170E; and light ray 34C-G from extraction reflector 170G.

Divergence 38 (197) is provided by the difference in the tilt τ between the extraction reflectors 170D. 170E.

Illustrative light rays 34C-DA, 34C-DB, 34C-E and 34U-E are transmitted through the pupil 44 onto the retina 46 to provide respective retinal points 35 (197)C-DA. 35 (197)C-DB, 35 (197)C-E and 35 (197) U-E that the eye 45 and HVS determine as from virtual image 30 with respective virtual image points 32C and 32U.

Light rays 34C-DA and 34C-DB are provided by reflection of rays 434CR from the same linear extraction reflector 170D and thus are parallel. Respective retinal points 35 (197)C-DA, 35 (197)C-DB at the retina 46 provide an image blur 33 (197) across the transverse direction 197. Such blur 33 (197) provides perceived blur 31 (197) of the virtual image point 32C across the transverse direction 197.

The alternative arrangement of extraction reflectors 170 of FIG. 2 may advantageously be fabricated with reduced complexity and cost. Finite image distance ZV₁₉₇ may be provided to achieve improved comfort of virtual image viewing.

It would be desirable to reduce the blur 31 (197) of the virtual image points 32.

FIG. 3A is a schematic diagram illustrating a side view of light output from the ANEDA 100 of FIG. 2 to provide a virtual image 30 at a finite viewing distance ZV₁₉₇ in the transverse direction 197 with reduced blur 31 (197) in comparison to the arrangement of FIG. 2. Features of the embodiment of FIG. 3A not discussed in further detail may be assumed to correspond to the features with equivalent reference numerals as discussed above, including any potential variations in the features.

By way of comparison with FIG. 2, the alternative embodiment of FIG. 3A illustrates that the extraction reflectors 170A-H are curved with a curvature ρ as will be described further in FIG. 3B hereinbelow. Such curvature ρ provides a variation in the deflection angle across each of the extraction reflectors 170 of the guided rays 434CR to provide output rays 34C that have a divergence 38. In operation, points 35 (197)C-EA. 35 (197)C-EB and 35 (197)C-F may be provided (in the appropriate focal condition of the eye 45) at the same location on the retina 46 and blur 33 (197) reduced, achieving improved visibility of virtual image point 32C with reduced blur 31 (197).

FIG. 3A further illustrates that the virtual image plane 41 (197) may be curved. Such curvature may arise from aberrations of the extraction reflectors 170 for example.

In alternative embodiments (not illustrated) some of the extraction features 170A-H may be curved and some may be linear. Advantageously reduced blur may be provided in some regions of the exit pupil 40 and in other regions blur 33 (197) may be increased but the fabrication cost and complexity of the extraction waveguide 1 may be reduced.

The structure and fabrication of the extraction waveguide 1 of FIG. 3A will now be described further.

FIG. 3B is a schematic diagram illustrating a side view of the construction of the extraction reflectors of FIG. 1A to provide a virtual image 30 at a finite viewing distance ZV₁₉₇ in the transverse direction 197; and FIG. 3C is a schematic diagram illustrating a front perspective view of light output from an alternative arrangement of an ANEDA 100 arranged to provide a virtual image 30 at a finite viewing distance Z. Features of the embodiments of FIGS. 3B-C not discussed in further detail may be assumed to correspond to the features with equivalent reference numerals as discussed above, including any potential variations in the features.

By way of comparison with FIG. 2, the alternative embodiments of FIGS. 3A-C and FIGS. 3A-B further illustrate that the extraction features 169 comprise extraction reflectors 170A-G that extend across part of the extraction waveguide 1 between front and rear guide surfaces 8, 6 of the extraction waveguide 1. Extraction reflector 170D has radius of curvature ρ_{D}, conic constant k_{D} and height h_{D} from the front guide surface 8 at the distance Y_{D} from the centre of the lateral anamorphic component 110. The variation of height h_{D} may provide increased transmitted light in the direction 193 along the waveguide 1 and advantageously achieve improved uniformity across the exit pupil 40.

An illustrative embodiment of extraction waveguide 1 is provided in TABLE 3.

TABLE 3

| Item | Property | |
|---|---|---|
| Waveguide 1 refractive index | 1.49 | |
| Input side 2 inclination, δ | 60° | |
| Waveguide 1 thickness, t | 3.00 | mm |
| SLM48 height w₁₉₇ in transverse direction 197 | 3.4 | mm |
| SLM48 width w₁₉₅ in lateral direction 195 | 45 | mm |
| Lens 61 focal length in transverse direction 197 | 8.60 | mm |
| Lateral mirror focal length in lateral direction 140, 110 | 35.02 | mm |

TABLE 4 illustrates an embodiment of extraction features 169 that are not embodiments of the present disclosure wherein the virtual image point 32 and virtual image plane 41 is provided at infinity. TABLE 4 is provided as a reference for the illustrative embodiments of TABLE 4 and TABLE 6.

TABLE 4

| | Lateral | Lateral conic | Transverse | | |
|---|---|---|---|---|---|
| | radius | constant | radius | Height | Tilt |
| | ρ₁₉₅/ | k₁₉₅/ | ρ₁₉₇/ | h₁₉₇/ | τ₁₉₇/ |
| Item | mm | mm | mm | mm | deg |
| Extraction | 0 | 0 | 0 | 1.40 | −30.00 |
| feature 174A-H | | | | | |
| Lateral | 105 | 0.58 | 0 | 3.0 | 0 |
| mirror 140, 110 | | | | | |

In the embodiments of FIGS. 3A-B, in the transverse direction 197, each extraction feature 169 is curved with the same curvature ρ₁₉₇. Advantageously the complexity of manufacture of the extraction features 169 is reduced. In alternative embodiments, each extraction feature 169 may be curved with a curvature 1/ρ₁₉₇ that changes along the extraction waveguide 1 in the second direction 193.

FIG. 3D are schematic diagrams illustrating in front-side perspective view a method to form the optical waveguide 1 of FIG. 2. Features of the embodiment of FIG. 3D not discussed in further detail may be assumed to correspond to the features with equivalent reference numerals as discussed above, including any potential variations in the features.

In a first step S1 a first waveguide member 111A comprises an array of extraction surfaces 181 and draft surfaces 183. The waveguide member 111A may be fabricated for example by moulding.

In a second step S2 the extraction surfaces 181 may be coated with material 171 to provide extraction reflectors 170. Material 171 may comprise a dichroic stack or may comprise a reflective material or partially reflective material such as an aluminium or silver coated surface of desirable thickness.

In a third step S3 waveguide member 11B with well 115 may be provided.

In a fourth step S4 an adhesive material is provided in the well 115 and the waveguide member 111A is inserted into the well 115. The adhesive material is cured for example by thermal cure or by exposure to a UV light source 417.

In a fifth step S5 the cured waveguide 1 is provided.

Provision of divergence 38 (195) in the lateral direction 195 will now be described.

FIG. 4A is a schematic diagram illustrating a front perspective view of an ANEDA 100 comprising extraction features 170 that are curved with negative optical power in the lateral direction 195 that is the same across the array of extraction features 170. Features of the embodiment of FIG. 4A not discussed in further detail may be assumed to correspond to the features with equivalent reference numerals as discussed above, including any potential variations in the features.

FIG. 4A further illustrates the embodiment of FIG. 1A wherein in the lateral direction 195, each extraction feature 169 is an extraction reflector 170 that is curved.

The lateral anamorphic component 110 and the extraction features 169 are configured such that the ANEDA 100 outputs light from a point 32 that has divergence 38 (195) in the lateral direction 195 so that, when the output light from the point 230 on the spatial light modulator 48 is viewed by the eye 45 of a viewer 47, the divergence 38 (195) of the output light allows the eye 45 of the viewer 47 to focus the output light from a finite viewing distance ZV₁₉₅ in the lateral direction 195.

Considering light from left side pixel 222L, the light rays 434LR within the extraction waveguide 1 and propagating in the second direction 193 are parallel after reflection from the light reversing reflector 140. The extraction features 169 are curved with negative optical power in the lateral direction 195 to cause divergence 38 (195) in the lateral direction 195 and the vergence 38 in the vergence in the lateral direction is divergence.

Further, as illustrated in FIG. 1A and FIG. 3B, the extraction features 169 have tilts τ that vary such that the output light is light from a point 32 that has divergence 38 (197) in the transverse direction 197 and, when the output light from the point 230 on the spatial light modulator 48 is viewed by the eye 45 of a viewer, the divergence 38 (197) of the output light allows the eye 45 of the viewer 47 to focus the output light from a finite viewing distance ZV₁₉₇ in the transverse direction 197.

FIG. 4B is a schematic diagram illustrating a front perspective view of an ANEDA comprising extraction features 170 that are straight in the lateral direction 195 and the shape of the lateral anamorphic component 110 is provided with additional negative optical power. Features of the embodiment of FIG. 4B not discussed in further detail may be assumed to correspond to the features with equivalent reference numerals as discussed above, including any potential variations in the features.

By way of comparison with FIG. 4A, the alternative embodiment of FIG. 4B illustrates that in the lateral direction 195, each extraction feature 169 is linear across the lateral direction 195 and the lateral anamorphic component 110 is configured to cause divergence 38 (195) in the lateral direction 195. The extraction features 169 are linear in the lateral direction 195 to cause no change of the divergence 38 (195) of the output light 34L in the lateral direction 195.

In comparison to FIG. 4A, divergence 38 (195) is provided by an adjustment to the lateral anamorphic component 110, for example the radius and/or conic constant of the end 4 of the extraction waveguide 1. Advantageously the cost and complexity of the extraction features 169 is reduced.

TABLE 5 shows an illustrative embodiment of the present disclosure arranged to provide the points 32 at a distance of 2 metres and using linear extraction features 169 in the lateral direction 195, for example as described further in FIG. 4B. By way of comparison with TABLE 4, the embodiment of TABLE 5 illustrates that the extraction reflectors 170 are tilted with tilts that vary along the second direction 193.

TABLE 5

| | | Lateral | Trans- | | |
|---|---|---|---|---|---|
| | Lateral | conic | verse | | |
| | radius | constant | radius | Height | Tilt |
| | ρ₁₉₅/ | k₁₉₅/ | ρ₁₉₇/ | h₁₉₇/ | τ₁₉₇/ |
| Item | mm | mm | mm | mm | deg |
| Extraction feature 174A | 0 | 0 | −6261 | 2.40 | −30.06 |
| Extraction feature 174B | 0 | 0 | −6261 | 2.20 | −30.04 |
| Extraction feature 174C | 0 | 0 | −6261 | 2.00 | −30.03 |
| Extraction feature 174D | 0 | 0 | −6261 | 1.80 | −30.01 |
| Extraction feature 174E | 0 | 0 | −6261 | 1.60 | −30.00 |
| Extraction feature 174F | 0 | 0 | −6261 | 1.40 | −29.99 |
| Extraction feature 174G | 0 | 0 | −6261 | 1.20 | −29.98 |
| Extraction feature 174H | 0 | 0 | −6261 | 1.00 | −29.97 |
| Extraction feature 174I | 0 | 0 | −6261 | 0.80 | −29.96 |
| Lateral mirror 140, 110 | 105 | 0.58 | −6261 | 3.00 | 0 |

FIG. 4C is a schematic diagram illustrating a front perspective view of an ANEDA comprising extraction features 170 that are curved in the lateral direction 195 with negative optical power that varies across the array of extraction features 170. Features of the embodiment of FIG. 4C not discussed in further detail may be assumed to correspond to the features with equivalent reference numerals as discussed above, including any potential variations in the features.

By way of comparison with FIG. 4A, the alternative embodiment of FIG. 4C illustrates that each extraction feature 169 is curved in the lateral direction 195 with a curvature 1/ρ₁₉₅ that changes along the extraction waveguide 1 in the second direction 193.

Considering light ray 434LR propagating within the extraction waveguide 1 in the second direction 193, output light rays 34L-A, 34L-B, 34L-C, 34L-D and 34L-E are output from reflective extractor 170A-E respectively. At the location of the incident ray 434LR onto each extraction feature 170A-E, the surface normal direction of the extraction reflector 170 varies in both the transverse direction 197 and the lateral direction 195. The curvature of the extraction reflector 170 in the lateral direction 195 may be varied along the waveguide 1 in the second direction 193 so that the output light rays 34L-A, 34L-B, 34L-C, 34L-D and 34L-E are provided with desirable divergence 38.

The location of the virtual image point 32L may not change for different eye 45 locations in the exit pupil 40, advantageously improving image stability.

FIG. 4D is a schematic diagram illustrating a front perspective view of an ANEDA comprising extraction features 170 that are curved with positive optical power in the lateral direction 195 and the shape of the lateral anamorphic component 110 is provided with additional negative optical power. Features of the embodiments of FIG. 4D not discussed in further detail may be assumed to correspond to the features with equivalent reference numerals as discussed above, including any potential variations in the features.

By way of comparison with FIG. 4A, the alternative embodiment of FIG. 4D illustrates the extraction features 169 are curved with positive optical power in the lateral direction 195 to reduce the divergence 38 (195) caused by the lateral anamorphic component 110 in the lateral direction 195 in a similar manner to that described in FIG. 4C. The location of the virtual image point 32L may not change for different eye 45 locations in the exit pupil 40, advantageously improving image stability.

The extraction reflectors 170 of FIG. 4D may further have a different curvature along the extraction waveguide 1 in the second direction 193 to improve stability of point 32 location in a similar manner to that described with reference to FIG. 4C.

TABLE 6 shows an illustrative embodiment of the present disclosure arranged to provide the points 32 at a distance of 2 metres and using curved extraction features 169 in the lateral direction 195, for example as described further in FIG. 4D. By way of comparison with TABLE 5 and FIG. 4B, the embodiment further comprises an adjusted arrangement of curvature of the light reversing reflector 140.

TABLE 6

| | | Lateral | Trans- | | |
|---|---|---|---|---|---|
| | Lateral | conic | verse | | |
| | radius | constant | radius | Height | Tilt |
| | ρ₁₉₅/ | k₁₉₅/ | ρ₁₉₇/ | h₁₉₇/ | τ₁₉₇/ |
| Item | mm | mm | mm | mm | deg |
| Extraction feature 174A | 1935.4 | 0 | −6261 | 2.40 | −30.06 |
| Extraction feature 174B | 1935.4 | 0 | −6261 | 2.20 | −30.04 |
| Extraction feature 174C | 1935.4 | 0 | −6261 | 2.00 | −30.03 |
| Extraction feature 174D | 1935.4 | 0 | −6261 | 1.80 | −30.01 |
| Extraction feature 174E | 1935.4 | 0 | −6261 | 1.60 | −30.00 |
| Extraction feature 174F | 1935.4 | 0 | −6261 | 1.40 | −29.99 |
| Extraction feature 174G | 1935.4 | 0 | −6261 | 1.20 | −29.98 |
| Extraction feature 174H | 1935.4 | 0 | −6261 | 1.00 | −29.97 |
| Extraction feature 174I | 1935.4 | 0 | −6261 | 0.80 | −29.96 |
| Lateral mirror 140, 110 | 101.4 | 0.68 | 0 | 3.00 | 0 |

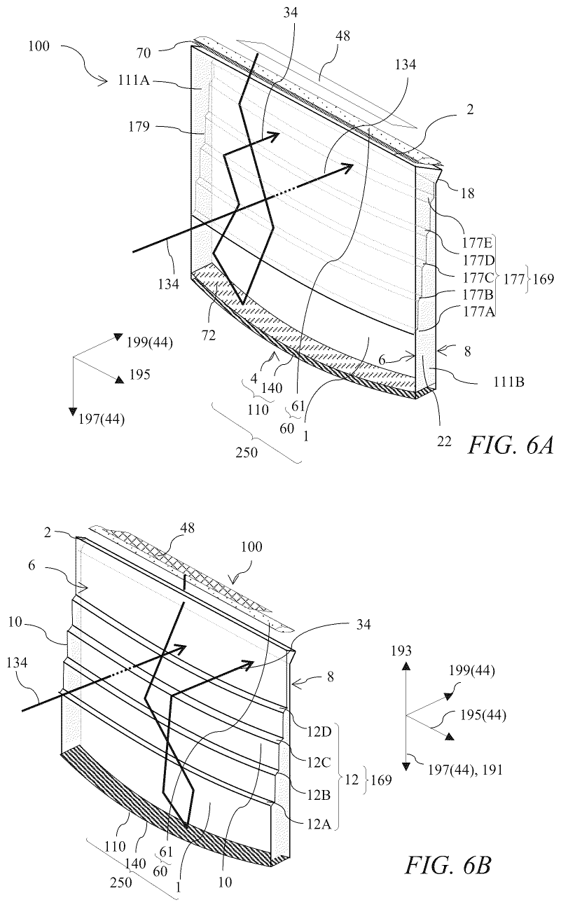

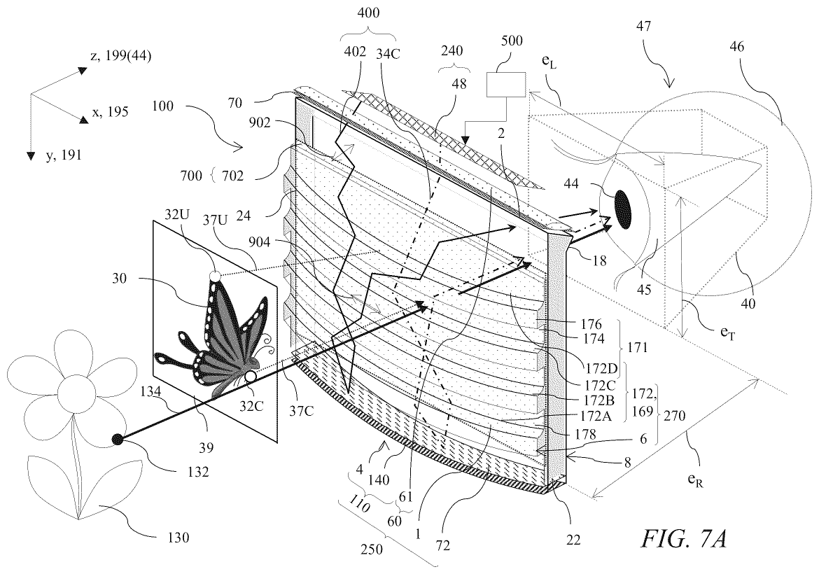

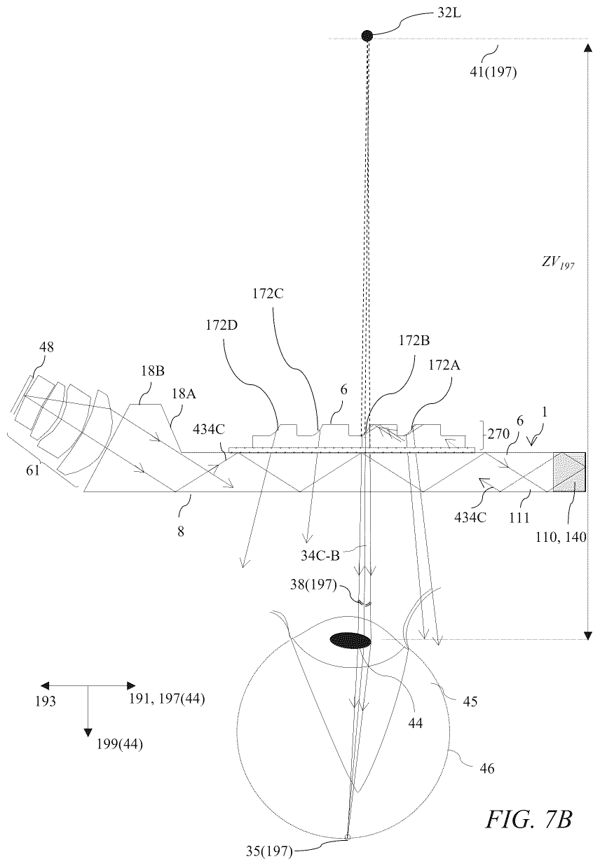

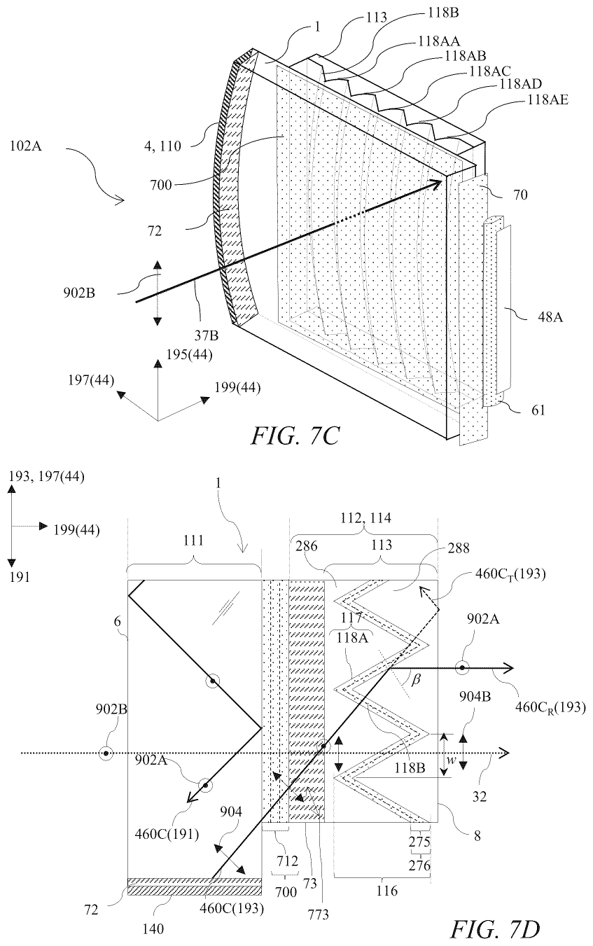

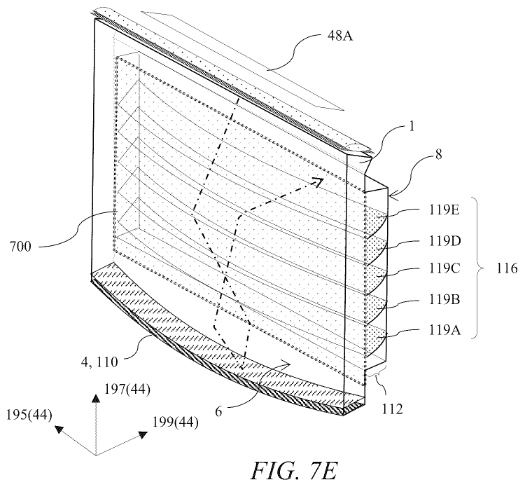

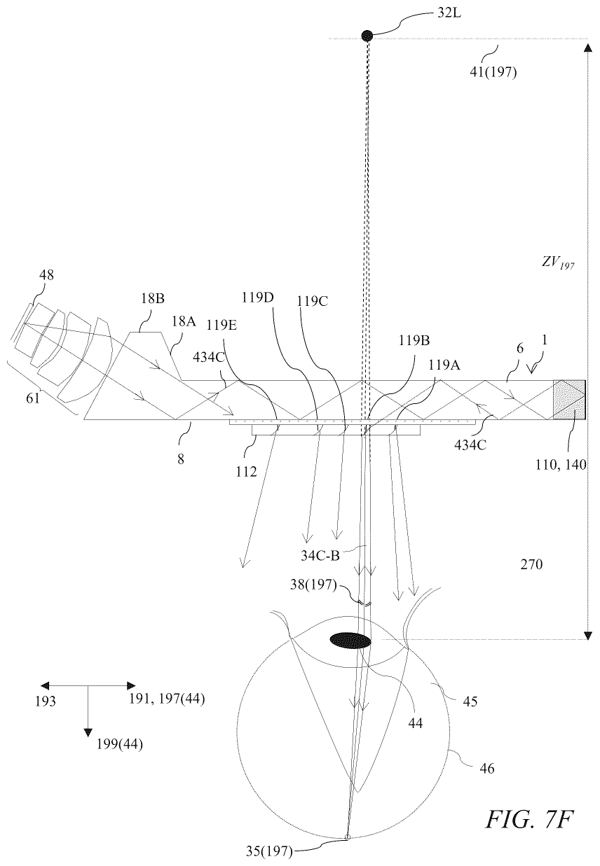

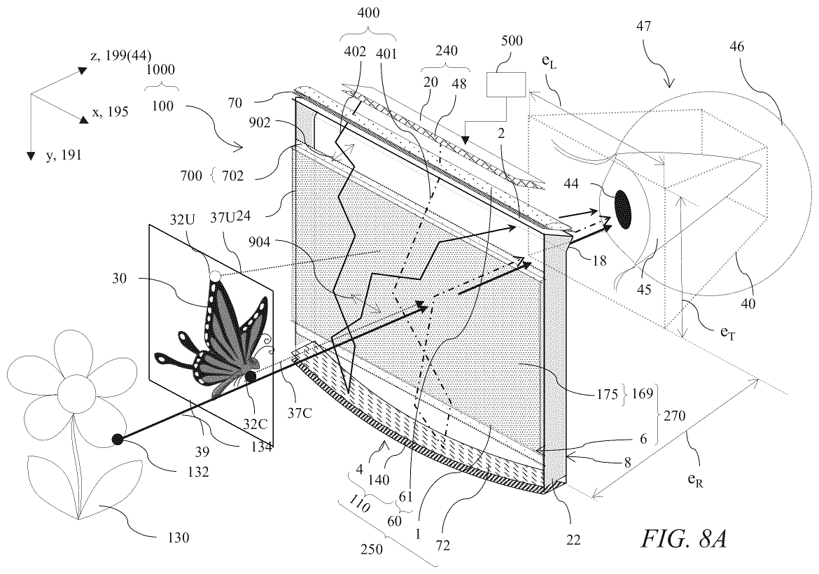

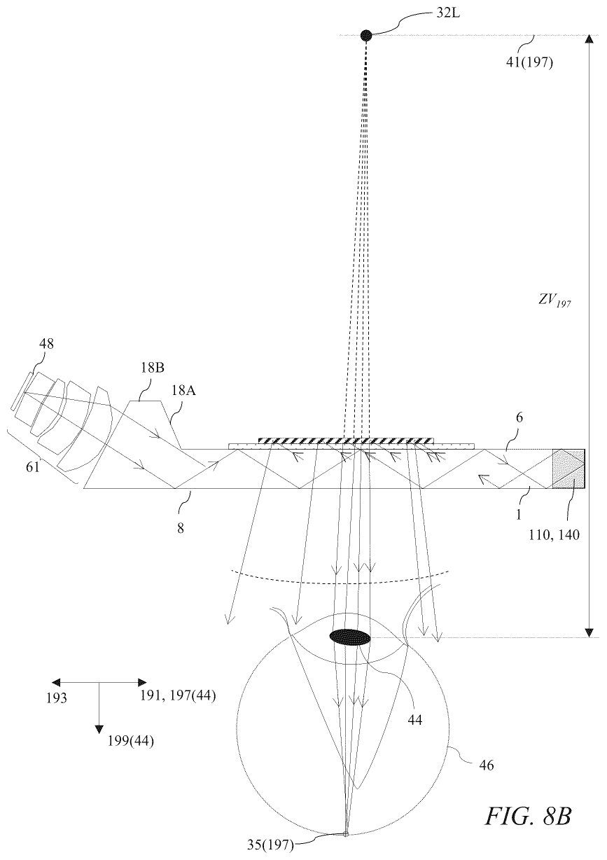

Alternative arrangements of extraction waveguide 1 will now be described. In the following examples, specific examples of the array of extraction features 169 are shown (for example being extraction reflectors 170 in FIG. 1A, extraction reflector steps 177 in FIG. 6A, surface steps 12 in FIG. 6B, extraction surfaces 172 in FIGS. 7A-B, diffractive optical elements 175 in FIGS. 8A-B and so on), but this is not limitative and in general any of the extraction features 169 disclosed herein may alternatively be applied in the following examples. Similarly, the various features of the following examples may be combined together in any combination.

The operation of the ANEDA 100 for various different visual correction conditions will now be described in further detail.

FIG. 5A is a schematic diagram illustrating a rear perspective view of an ANEDA 100 further comprising a corrective lens 290 to compensate for ophthalmic conditions of the eye 45 of the viewer 47. Features of the embodiment of FIG. 5A not discussed in further detail may be assumed to correspond to the features with equivalent reference numerals as discussed above, including any potential variations in the features.

In the alternative embodiment of FIG. 5A, the ANEDA 100 further comprises at least one lens 290 that may be a corrective lens having optical power for correcting eyesight. The correction of eyesight may be for example to correct for presbyopia, astigmatism, myopia or hyperopia of the display user 45.

The operation of the ANEDA 100 for various different visual correction conditions will now be described in further detail.

FIG. 5B is a schematic diagram illustrating in side and top views light output 34 from an ANEDA 100 not comprising the curved light extraction features 169 of the type of FIG. 1A; and FIG. 5C is a schematic diagram illustrating in side and top views light output 34 from an ANEDA 100 of the type of FIG. 1A. Features of the arrangement of FIG. 5B and embodiment of FIG. 5C not discussed in further detail may be assumed to correspond to the features with equivalent reference numerals as discussed above, including any potential variations in the features.

By way of comparison with FIG. 1A, the arrangement of FIG. 5B may be provided by light extraction features 169 that are linear in the transverse and lateral directions 197, 195 and the lateral anamorphic component 110 is arranged to provide collimated light from a point in the spatial light modulator 48.

Light rays 34C representing a point at the pixel 222C are parallel across both the transverse and lateral directions 197, 195 and so have zero divergence 38; similarly light rays 34B, 34U and light rays 34L, 34M, 34R are parallel with zero divergence 38. Such an arrangement does not allow the eye 45 of the viewer 47 to focus the output light from a finite viewing distance ZV, the viewing distance ZV being for an infinite conjugate. For an output ray 34 location from the ANEDA 100, the rays 34B, 34C, 34U provide divergence ϕᵣ with respect to each other; and the rays 34L, 34M, 34R are diverging with divergence ϕ_{L} with respect to each other. Divergences ϕ_{T}, ϕ_{L} represent the angular field of view of the ANEDA 100 in the transverse and lateral directions 197, 195 if the rays 34U, 34B, 34L, 34R are from the outer pixels 222U, 222B. 222L, 222R of the spatial light modulator 48. The divergences ϕ_{T}, ϕ_{L} at said output ray 34 location are different from the divergence 38 (197), 38 (195) of the rays 34 from a point on the spatial light modulator 48.

By way of comparison with FIG. 5B, the embodiment of FIG. 5C illustrates the corresponding divergences 38 (197), 38 (195) for the embodiments of the present disclosure for example as illustrated in FIG. 1A wherein a virtual image 30 is provided for a finite viewing distance ZV. The arrangement of FIG. 5C is suitable for well-corrected vision of the eye 45.

It may be desirable to provide an ANEDA 100 so that a far field object 130 and a virtual image 30 is provided with appropriate divergences 38 (197), 38 (195) to correct for ophthalmic prescription needs of the eye 45 of the viewer 47 such that images 36, 136 may be provided with appropriate focus onto the retina 46. On selection of the ANEDA 100 for each eye, a viewer 47 may select a waveguide 1 with the appropriate divergences 38 (195) and 38 (197) to provide visual correction including myopia, hypermetropia, astigmatism and presbyopia.

FIG. 5D is a schematic diagram illustrating in side and top views light output 34 from an ANEDA 100 of the type of FIG. 1A and further arranged to provide vision correction for a hyperopic eye 45 of a viewer 47. Features of the embodiment of FIG. 5D not discussed in further detail may be assumed to correspond to the features with equivalent reference numerals as discussed above, including any potential variations in the features.

An illustrative hyperopic eye 45 may use a positive corrective lens 290 for viewing distant objects 130; and for nearby objects may use a different spectacle lens correction with yet higher positive optical power.

In the alternative embodiment of FIG. 5D, the ANEDA 100 is provided between the corrective lens 290 and the eye 45 so that the usable eye relief e_{R} for the eye 45 is maximised and viewer 47 freedom improved. By way of comparison with FIG. 5C, the alternative embodiment of FIG. 5D illustrates that the vergence is a convergence 38 provided from the ANEDA 100 to achieve a virtual image 30 distance ZV that is on the output side of the ANEDA 100 and in the arrangement of FIG. 5D, the virtual image 30 from the ANEDA is positioned behind the eye 45, so the viewing distance ZV is a finite negative distance. Distant objects 130 are provided in focus onto the retina 46 using positive corrective lens 290 and focused retinal images 36 are provided from the ANEDA 100 to the eye by the convergence 38.

FIG. 5E is a schematic diagram illustrating in side and top views light output from an ANEDA 100 of the type of FIG. 1A and further arranged to provide vision correction for a myopic astigmatic eye 45 of a viewer 47; FIG. 5F is a schematic diagram illustrating in side view operation of a diverging corrective lens 290 for a myopic eye 45; FIG. 5G is a schematic diagram illustrating in side view operation of the arrangement of FIG. 5E wherein the virtual image 30 is arranged for an infinite conjugate distance ZV; and FIG. 5H is a schematic diagram illustrating in side views operation of the arrangement of FIG. 5E wherein the virtual image is arranged for a finite conjugate distance ZV. Features of the embodiment of FIGS. 5E-H not discussed in further detail may be assumed to correspond to the features with equivalent reference numerals as discussed above, including any potential variations in the features.

In the alternative embodiments of FIGS. 5E-H, a myopic eye 45 may be provided with a negative corrective lens 290 to correct for far-field viewing, that is to bring into sharp focus an object 130 arranged at an infinite conjugate such that image 136 is arranged on the retina 46 for comfortable viewing.

The alternative embodiment of FIGURE SE may have an ANEDA 100 with operation that is similar to the embodiment of FIG. 5C, however the divergence 38 may be different, as will be illustrated in FIGS. 5G-H hereinbelow. FIGURE SE further illustrates that the astigmatism of the eye 45 may be corrected in which the distances ZV₁₉₅, ZV₁₉₇ are set differently to compensate for astigmatism of the eye 45 of a viewer 47 and optionally different for each eye 45L, 45R. Advantageously further corrective spectacles between the waveguide 1 and the eye 45 may be omitted and the desirable eye relief e_{R} reduced, achieving increased field of view.

By way of comparison with the present embodiments, FIG. 5F illustrates the correction of a myopic eye 45 for viewing of a distant object 130 with parallel rays 134 from an infinite conjugate distance ZR. The unaided eye 45 has too much optical power and the eye cannot focus the image 136 correctly onto the retina 46. The negative corrective lens provides a virtual image distance ZL that is the viewing distance for the eye 45 by providing divergence 298 of the rays 134 from the lens 290 towards the eye 45. The eye 45 of the viewer 47 focuses the light rays 134 from the finite viewing distance ZL onto the retina 46.

In the embodiment of FIG. 5G, the extraction features 169 of the ANEDA 100 are arranged to provide divergence 38 which is the same as the divergence 298 provided by the negative corrective lens 290 for an infinite conjugate distance ZR. The finite viewing distance ZV is the same as the viewing distance ZL for the lens 290 and ANEDA 100.

By way of comparison with FIG. 5C, the magnitude of the divergence 38 of the rays 34 for FIGS. 5G-H may be different to the magnitude of the divergence for well-corrected vision of FIG. 5C, for example the divergence 38 may be increased.

By way of comparison with FIG. 5G, in the alternative embodiment of FIG. 5H, the extraction features 169 of the ANEDA 100 are arranged with further increased divergence 38, which is greater than the divergence 298 provided by the negative corrective lens 290 for an infinite conjugate distance ZR, so that a finite viewing distance ZV is provided for the virtual image 30 and the finite image distance ZL is provided for the real-world object 130.

In an illustrative example, a myopic viewer 47 with maximum comfortable focus distance of 0.5 metre may be provided with a negative power corrective lens 290 that provides sharp imaging of distant objects 130 for the viewing distance ZL of 0.5 metres and a viewing distance ZV of 0.25 metres.

FIG. 6A is a schematic diagram illustrating a rear perspective view of an alternative ANEDA 100 arranged to provide a virtual image 30 at a finite viewing distance Z wherein the optical waveguide 1 comprises light extraction features 169 that are provided as extraction reflector steps 177 in an array through the optical waveguide 1. Features of the embodiment of FIG. 6A not discussed in further detail may be assumed to correspond to the features with equivalent reference numerals as discussed above, including any potential variations in the features.

By way of comparison with FIG. 1A, the alternative embodiment of FIG. 6A illustrates that the extraction features 169 comprise extraction reflector steps 177A-E that extend across at least part of the extraction waveguide 1 between front and rear guide surfaces 8, 6 of the extraction waveguide 1.

The extraction reflector steps 177 are inclined with respect to the first and second directions 191, 193 along the optical axis 199 of the extraction waveguide 1. The extraction reflector steps 177 extend partially across the extraction waveguide 1 between the opposing rear and front guide surfaces 6, 8.

The extraction waveguide 1 comprises intermediate surfaces 179 extending along the extraction waveguide between adjacent pairs of extraction reflector steps 177. In the embodiment of FIG. 6A, intermediate surfaces 179 are arranged between pairs of extraction reflector steps 177A-B, 177B-C, 177C-D and 177D-E.

Extraction reflector steps 177 and intermediate surfaces 179 may be provided between first and second waveguide members 111A, 111B. Suitable dielectric, birefringent or polarisation-sensitive coatings may be provided on at least one of the waveguide members 111A, 111B to provide extraction reflector steps 177 and intermediate surfaces 179 that transmit light in the first direction 191 and reflect light in the second direction 193 from the extraction reflector steps 177. Advantageously cost and complexity of fabrication may be reduced.

The operation of the extraction reflector steps 177 to provide virtual image points 32 is similar to that described in hereinabove, wherein divergence 38 of output light rays 34 is provided.

The extraction reflector steps 177 may have in transverse direction 197 a planar surface profile similar to that illustrated in FIG. 2; and may have the curved surface profile similar to that illustrated in FIG. 3A. The extraction reflector steps 177 may have in lateral direction 195 the curvatures as illustrated in FIGS. 4A-D hereinabove. Advantages similar to those indicated therein may be achieved.

Alternative arrangements of extraction waveguide 1 wherein the extraction features 169 are provided between the rear and front light guide surfaces 6, 8 are described further in U.S. Patent Publ. No. 2023-0418034, which is herein incorporated by reference in its entirety. Variations of extraction features 169 described therein may be arranged to achieve the divergence 38 of the output light 34 and allow the eye 45 of the viewer 47 to focus the output light 34 from a finite viewing distance ZV in at least one of the transverse direction 197 and lateral direction 195 as described elsewhere herein.

FIG. 6B is a schematic diagram illustrating a rear perspective view of an alternative ANEDA 100 arranged to provide a virtual image 30 at a finite viewing distance Z wherein the optical waveguide 1 comprises light extraction features 169 that are provided as surface steps 12 on the rear surface 6 of the waveguide 1. Features of the embodiment of FIG. 6B not discussed in further detail may be assumed to correspond to the features with equivalent reference numerals as discussed above, including any potential variations in the features.

By way of comparison with FIG. 1A, the alternative embodiment of FIG. 6B illustrates that the extraction waveguide 1 has a front guide surface 8 and a rear guide surface 6, and the rear guide surface 6 comprises extraction surfaces 12A-D that are the extraction features 169, each extraction surface 12 being arranged to reflect light guided in the second direction 193 towards an eye 45 of a viewer through the front guide surface 8.

For light propagating in the first direction 191 from the input end 2, the surfaces 12 are hidden while some returning light after reflection from the light reversing reflector 140 in the second direction 193 is incident onto the extraction surfaces 12 and is extracted by total internal reflection. Advantageously the polariser 70 may be omitted and efficiency increased. Cost and complexity of fabrication may be reduced.

The extraction surfaces 12 may have in transverse direction 197 a planar surface profile similar to that illustrated in FIG. 2; and may have the curved surface profile similar to that illustrated in FIG. 3A. The extraction surfaces 12 may have in lateral direction 195 the curvatures as illustrated in FIGS. 4A-D hereinabove. Advantages similar to those indicated therein may be achieved.

Alternative arrangements of extraction waveguide 1 wherein the extraction features 169 are provided between the rear and front light guide surfaces 6, 8 are described further in U.S. Pat. No. 9,594,261, which is herein incorporated by reference in its entirety. Variations of extraction features 169 described therein may be arranged to achieve the divergence 38 of the output light 34 and allow the eye 45 of the viewer 47 to focus the output light 34 from a finite viewing distance ZV in at least one of the transverse direction 197 and lateral direction 195 as described elsewhere herein.

It may be desirable to hide extraction features 169 for light propagating in the first direction 191.

FIG. 7A is a schematic diagram illustrating a rear perspective view of an alternative ANEDA 100 arranged to provide a virtual image 30 at a finite viewing distance Z wherein the optical waveguide 1 comprises light extraction features 169 that are provided as surface steps 12 on the rear surface 6 of the waveguide 1 and outside a polarisation-sensitive reflector (PSR) 700; and FIG. 7B is a schematic diagram illustrating a side view of the operation of the ANEDA 100 of FIG. 7A. Features of the embodiment of FIGS. 7A-B not discussed in further detail may be assumed to correspond to the features with equivalent reference numerals as discussed above, including any potential variations in the features.

By way of comparison with FIG. 1A the alternative embodiment of FIGS. 7A-B illustrates an ANEDA 100 wherein: the extraction waveguide 1 comprises: a front guide surface 8; a PSR 700 opposing the front guide surface 8; and an extraction element 270 disposed outside the PSR 700, the extraction element 270 comprising: a rear guide surface 6 opposing the front guide surface 8; and the array of extraction features 169; the ANEDA 100 is arranged to provide light guided along the extraction waveguide 1 in the first direction 191 with an input linear polarisation state before reaching the PSR 700; and the optical system 250 further comprises a polarisation conversion retarder 72 disposed between the PSR 700 and the light reversing reflector 140, wherein the polarisation conversion retarder 72 is arranged to convert a polarisation state of light passing therethrough between a linear polarisation state and a circular polarisation state, and the polarisation conversion retarder 72 and the light reversing reflector 140 are arranged in combination to rotate the input linear polarisation state of the light guided in the first direction 191 so that the light guided in the second direction 193 and output from the polarisation conversion retarder 72 has an orthogonal linear polarisation state that is orthogonal to the input linear polarisation state; the PSR 700 is arranged to reflect light guided in the first direction 191 having the input linear polarisation state and to pass light guided in the second direction 193 having the orthogonal linear polarisation state, so that the front guide surface 8 and the PSR 700 are arranged to guide light in the first direction 191, and the front guide surface 8 and the rear guide surface 6 are arranged to guide light in the second direction 193; and the array of extraction features 169 is arranged to extract light guided along the extraction waveguide 1 in the second direction 193 towards an eye 45 of a viewer through the front guide surface 8, the array of extraction features 169 being distributed along the extraction waveguide 1 so as to provide exit pupil 40 expansion in the transverse direction 197.

The PSR 700 comprises a reflective linear polariser 702. In alternative embodiments, the PSR 700 may comprise a dichroic stack with reflection properties similar to that shown in TABLE 1 and may be similar in structure to that illustrated in TABLE 2. In alternative embodiments, the PSR 700 may comprise a liquid crystal layer such as a cured reactive mesogen liquid crystal layer. The refractive indices of the waveguide 1 material and liquid crystal material of the PSR may be provided to achieve guiding of the polarisation state 902 propagating in the first direction 191 and to provide transmission of the polarisation state 904 propagating in the second direction 193. In alternative embodiments, a combination of at least two of a dichroic stack, a reflective polariser and a liquid crystal layer may be used to achieve enhanced light guiding and transmission properties. Advantageously the uniformity of operation over the light conc propagating within the waveguide 1 may be increased and the field of view in the transverse direction may be increased.

The extraction waveguide 1 comprises a rear guide surface 6 and a PSR 700 opposing the rear guide surface 6. The extraction waveguide 1 comprises waveguide member 111 arranged between the rear guide surface 6 and the PSR 700, wherein light 434C guides through the waveguide member 111 in the first direction 191. PSR 700 may not extend along the entirety of the waveguide member 111.

Extraction element 270 is disposed outside the PSR 700, the extraction element 270 comprising: the rear guide surface 6 opposing the front guide surface 8; and an array of extraction features 169.

The array of extraction features 169 is arranged on the rear guide surface 6 that comprises plural prisms 171 that protrude outwardly. The prisms 171 each comprise at least one extraction surface 172, and at least one draft facet 174. At least one primary guide facet 176 may be arranged between the respective at least one extraction surface 172 and the at least one draft facet 174. The rear guide surface 6 further comprises guide portions 178 between the prisms 171.

The array of extraction features 169 comprises extraction surfaces 172A-D, each extraction surface 172 being arranged to reflect light 401, 402 guided in the second direction 193 towards the eye 45 of the viewer 47 through the front guide surface 8.

The array of extraction surfaces 172A-D are distributed along the extraction waveguide 1 so as to provide exit pupil 40 expansion in the transverse direction, in a similar manner to that described elsewhere herein.

The extraction surfaces 172A-D may have in transverse direction 197 a planar surface profile similar to that illustrated in FIG. 2; and may have the curved surface profile similar to that illustrated in FIG. 3A. The extraction surfaces 172 may have in lateral direction 195 the curvatures as illustrated in FIGS. 4A-D hereinabove. Advantages similar to those indicated therein may be achieved.

By way of comparison with the embodiment of FIG. 1A, the alternative embodiment of FIGS. 7A-B may achieve reduced stray light rays for light 434 propagating in the first direction 191 along the waveguide member 111. Efficiency is increased and image fidelity may be improved.

Alternative arrangements of light extraction features will now be described.

FIG. 7C is a schematic diagram illustrating a rear perspective view of an alternative ANEDA 100 arranged to provide a virtual image 30 at a finite viewing distance ZV wherein the optical waveguide 1 comprises alternative light extraction features comprising curved deflection features 118AA-AE, with draft facets 118B that are provided on the front surface 8 of the waveguide 1 and outside the polarisation-sensitive reflector; and FIG. 7D is a schematic diagram illustrating a side view of light extraction and light transmission by the ANEDA 100. Features of the embodiment of FIGS. 7C-D not discussed in further detail may be assumed to correspond to the features with equivalent reference numerals as discussed above, including any potential variations in the features.

In comparison to the arrangement of FIG. 7A, in the alternative embodiment of FIGS. 7A-B the direction 191 in which the extraction waveguide 1 extends in the horizontal direction for the eyes 45 of the user. Thus the lateral direction 195 for the pupil 44 is vertical and the transverse direction 197 is horizontal. The near-eye display apparatus 100 may have reduced bulk of the sides of the head-worn display apparatus 600. The arrangement of light deflection features 118 of FIG. 7C or light deflection features 119 of FIG. 7E hereinbelow or light extraction features as described elsewhere herein may be used in either the orientations of FIG. 7C or 7E, that is the selection of light extraction feature does not determine the orientation of the waveguide 1 with respect to the eye 45.

The extraction of light from the extraction waveguide 1 of FIG. 7C will now be considered further.

FIG. 7D illustrates a detail of light ray 460C (193) that is reflected by the light reversing reflector 140.

The polarisation-sensitive reflector 700 is arranged to pass light 460C (193) guided in the second direction 193 having the orthogonal linear polarisation state 904 so that the passed light is incident on the deflection element 116. Thus the input linear polarisation state of ray 460C (191) is an s-polarisation state 902 in the extraction waveguide 1, and the ray 460C (193) has the orthogonal linear polarisation state that is a p-polarisation state 904 in the extraction waveguide. Advantageously high efficiency of transmission for light propagating in the first direction 191 along the extraction waveguide 1, and high efficiency of extraction for light propagating in the second direction 193 may be achieved.

The first optical apparatus 50A further comprises an intermediate polarisation conversion retarder 73 arranged between the polarisation-sensitive reflector 700 and the deflection element 116, the intermediate polarisation conversion retarder 73 being arranged to convert a polarisation state of light passing therethrough between the orthogonal linear polarisation state 904 and the linear polarisation state 902.

Light incident in the second direction 193 onto the polarisation-sensitive reflector 700 has a polarisation state 904, and the light is transmitted by the polarisation-sensitive reflector 700. The intermediate polarisation conversion retarder 73 has an optical axis direction 773 and outputs the s-polarisation state 902 which is incident onto the deflection arrangement 112.

FIG. 7D illustrates a front waveguide 114, deflection arrangement 112 comprising deflection elements 116 comprising deflection features 118A and draft facet 118B wherein the reflector 117 comprises the deflection feature 118A. Front waveguide 114 has a front guide surface 8 on the opposite side from the polarisation-sensitive reflector 700 of the front waveguide 114.

TABLE 7 shows an illustrative embodiment of the geometry of the arrangement of FIGS. 5A-B for an extraction waveguide 1 refractive index of 1.5.

TABLE 7

| Angle compared to direction 191 along | Illustrative |
|---|---|
| the extraction waveguide 1 | embodiment |
| Input end 2 inclination, δ | 60° |
| Tapered surface 18 inclination, χ | 44° |
| Cone 491_{T} half angle in the material of | 10° |
| the extraction waveguide, τ | |
| Reflector 117 tilt angle, β | 60° |
| Draft facet 118B tilt angle, α | 60° |
| Angle of incidence of central output ray | 90° |
| 460 C. at output surface 8, κ | |

The deflection features 118A are disposed internally within the front waveguide 114. In the embodiment of FIG. 7D, the deflection arrangement 112 and the front waveguide 114 each comprise the polarisation conversion retarder 73, and the deflection arrangement member 113 comprising the front element 288, the rear element 286 and a dichroic stack 276.

The front waveguide 114 comprises a front element 288 and a rear element 286 having a partially reflective layer 275 disposed therebetween wherein the partially reflective layer 275 comprises a dichroic stack 276.

Dielectric stack 712 comprises multiple dielectric layers 714A-E with an illustrative embodiment in TABLE 2 hereinabove.

The partially reflective layer 275 comprises first and second sections of opposite inclination alternating in a direction 193 along the front waveguide 114, the first sections comprising deflection feature 118A that is a reflective reflector 117 and the second sections comprising draft facet 118B arranged to pass the light passed by the polarisation-sensitive reflector 700 that is incident thereon.

The deflection features 118A and transmission features 118B are elongate and curved in the lateral direction 195, to provide a wide exit pupil 40 size in the lateral direction 195 and to provide virtual image 30 at a finite image distance ZV as described elsewhere herein and in a similar manner to the extraction features 172A-E of FIG. 7F hereinbelow.

The deflection features 118A of the deflection element 116 comprise sections that are separated in a direction 193 along the front waveguide 114 to provide exit pupil 40 expansion in the transverse direction 197. The reflectors 117 of the deflection features 118A are partially reflective reflectors 117, each comprising a partially reflective layer 275.

The deflection arrangement 112 is arranged to deflect at least part of the light 460C_{R} (193) passed by the polarisation-sensitive reflector 700 that is incident thereon towards an output direction 199 (44) forwards of the anamorphic directional illumination device 100.

Alternatively or additionally, the partially reflective layer 275 may comprise a metallic partially reflective layer. Advantageously the uniformity and efficiency of deflection may be improved.

The light deflection arrangement 112 may be formed by depositing the dielectric layers 714 of the dichroic stack 276 onto the front or rear elements 288, 286 that may be prismatic films. After deposition of the dichroic stack 276, a planarization layer 288 may be provided for the other of the front or rear elements 288, 286, and further providing the front guide surface 8 or a surface for attachment to the intermediate polarisation control retarder 73.

The size w of the reflector 117 may be arranged to minimise diffractive blur in the image seen by the user. Advantageously improved fidelity of image quality may be achieved.

FIG. 7E is a schematic diagram illustrating a rear perspective view of an alternative ANEDA 100 arranged to provide a virtual image 30 at a finite viewing distance ZV wherein the optical waveguide 1 comprises light extraction features that are deflection features 119A-E that are provided on the front surface 8 of the waveguide 1 and outside a PSR 700. Features of the embodiment of FIG. 7E not discussed in further detail may be assumed to correspond to the features with equivalent reference numerals as discussed above, including any potential variations in the features.

By way of comparison with FIG. 7A, in the alternative embodiment of FIG. 7E, the deflection arrangement 112 comprises a deflection element 116 comprising an array of deflection features 119A-E that are arranged between the rear and front sides of the deflection arrangement member 113, wherein the rear side of the deflection arrangement is next to the retarder 73 and the front side is the front guide surface 8. By way of comparison with the operation of FIGS. 7C-D, no draft facets 118B are provided.

The deflection features 119A-E may comprise dichroic stacks, reflective linear polarisers, mirrors, partial mirrors or liquid crystal layers as described elsewhere herein. Higher efficiency of operation and reduced stray light may advantageously be achieved and stray light and double imaging reduced.

FIG. 7F is a schematic diagram illustrating a side view of the operation of the ANEDA of FIG. 7E. Features of the embodiment of FIG. 7F not discussed in further detail may be assumed to correspond to the features with equivalent reference numerals as discussed above, including any potential variations in the features.

By way of comparison with FIG. 7B, in the alternative embodiment of FIG. 7F, the curved extraction features 119A-E are arranged on the front side of the optical waveguide 1. Extracted light does not pass back through the PSR 700 or the waveguide 1 and stray light may be reduced. Advantageously improved image contrast may be achieved.

Further descriptions and alternatives of the embodiments of FIGS. 7C-F are described in U.S. Patent Publ. No. 2024-0427123, which is herein incorporated by reference in its entirety. The embodiments of FIG. 7C-F may be further used as alternatives for ANEDA 100 in other embodiments described herein to advantageously achieve improved image contrast.

FIG. 8A is a schematic diagram illustrating a rear perspective view of an alternative ANEDA 100 arranged to provide a virtual image 30 at a finite viewing distance Z wherein the optical waveguide 1 comprises light extraction features 169 that are diffractive light extraction features 175 outside a PSR 700; and FIG. 8B is a schematic diagram illustrating a side view of the operation of the ANEDA 100 of FIG. 8A. Features of the embodiment of FIGS. 8A-B not discussed in further detail may be assumed to correspond to the features with equivalent reference numerals as discussed above, including any potential variations in the features.

By way of comparison with FIG. 1A, the alternative embodiment of FIGS. 8A-B illustrates that the extraction waveguide 1 has a front guide surface 8 and a rear guide surface 6, and the rear guide surface 6 comprises a diffractive optical element 175 comprising the extraction features 169.

The diffractive optical element 175 may comprise diffractive structure disposed within the extraction waveguide 1 comprising modulated phase grating comprising the array of reflective extraction features so that the diffractive optical element 175 is arranged to provide reflection of incident light through the front light guide surface 8 to the exit pupil 40.

The diffractive optical element 175 may be arranged to provide divergence 38 for reflected light rays 34C so as to provide virtual image point 32 in a similar manner to that described elsewhere herein. In manufacture, the diffractive optical element 175 may be recorded with appropriate illumination wavefront so as to provide appropriate deflection of the light 434 that varies across the area of the diffractive optical element 175.

The extraction waveguide 1 of FIG. 8B may be formed by forming the PSR 700 on the rear surface of waveguide member 111 and forming the diffractive optical element 175 on the PSR 700. Advantageously thickness may be reduced.

In comparison to the prism structures 171 comprising reflective facets 172 of FIGS. 7A-B, the embodiment of FIG. 8B provides reduced blurring due to diffraction from the large aperture width, w of the diffractive extraction feature 175. Advantageously image resolution may be increased.

The spectral bandwidth of reflection may be increased by providing chirped or multiple volume diffractive optical elements 175.

Alternative arrangements of the extraction waveguide 1 wherein the extraction features 169 are provided between the rear and front light guide surfaces 6, 8 are described further in U.S. Patent Publ. No. 2024-0061248, which is herein incorporated by reference in its entirety. Variations of extraction features 169 described therein may be arranged to achieve the divergence 38 of the output light 34 and allow the eye 45 of the viewer 47 to focus the output light 34 from a finite viewing distance ZV in at least one of the transverse direction 197 and lateral direction 195 as described elsewhere herein.

Exit pupil 40 expansion in the transverse direction 197 will now be described.

FIG. 9A is a schematic diagram illustrating a side view of a transverse exit pupil 40 provided by a single transverse anamorphic component 60 comprising a lens 61 stack; and FIG. 9B is a schematic diagram illustrating a side view of exit pupil 40 expansion in the transverse direction 197 of the ANEDA 100 of FIG. 1A. Features of the embodiment of FIGS. 9A-B not discussed in further detail may be assumed to correspond to the features with equivalent reference numerals as discussed above, including any potential variations in the features.

FIG. 9A illustrates the transverse eyebox 40 (197) that would be achieved if a single lens 61 were to be directed by the optical system 250 to the eye 45. Such eyebox 40 (197) would be limited in size by the size of the lens 61. It is desirable to provide eyebox 40 (197) expansion in the transverse direction 197.

For illustrative purposes FIG. 9B shows multiple images 611A, 611B, 611C of the lens 61 that are provided by the rays 460C_{T} (193) of FIG. 6A which in turn provides replication of resulting exit pupils 40A (197), 40B (197), 40C (197). Advantageously eyebox 40 (197) total size is increased, and image vignetting is reduced for desirable eye movement.

Formation of exit pupil 40 for the lateral direction 195 will now be described.

FIG. 9C is a schematic diagram illustrating a front perspective view of the lateral exit pupil 40 provided by the lateral anamorphic component 110 comprising a light reversing reflector 140. Features of the embodiment of FIG. 9C not discussed in further detail may be assumed to correspond to the features with equivalent reference numerals as discussed above, including any potential variations in the features.

FIG. 9C illustrates the propagation of light rays from left side pixel 222AL and right side pixel 222AR of the SLM 48A. The lateral anamorphic component 110 provides ray bundles 662L, 662R respectively, with divergences 38L (195), 38R (195) that are typically the same.

Exit pupil 40 (195) has size e_{L} at the eye relief e_{R}. The lateral anamorphic component 110 has a width determined by the width of the extraction waveguide 1 and the ANEDA 100 thus provides a large exit pupil that does not require the pupil expansion approach in the transverse direction 197 of FIG. 9B. Advantageously brightness and image uniformity is increased in comparison to optical waveguides that require pupil expansion in both lateral and transverse directions 195, 197.

Illustrative arrangements of first pixels 222A of the spatially multiplexed SLM 48A will now be described.

FIGS. 10A-D are schematic diagrams illustrating in front views arrangements of anamorphic pixels 222 of a SLM 48 for use in the ANEDA 100 of FIG. 1 and comprising spatially multiplexed red, green and blue sub-pixels 222R, 222G, 222B. Features of the embodiment of FIGS. 10A-D not discussed in further detail may be assumed to correspond to the features with equivalent reference numerals as discussed above, including any potential variations in the features.

The first SLM 48A may be a transmissive spatial light modulator such as a TFT-LCD further comprising a backlight. Alternatively the first SLM 48A may be a reflective spatial light modulator such as Liquid Crystal on Silicon (LCOS) or a Microoptoelectromechanical (MOEMS) array of micro-mirrors such as the DMD from Texas Instruments. Alternatively the first SLM 48A may be an emissive spatial light modulator using material systems such as OLED or inorganic micro-LED. A silicon backplane may be provided to achieve high speed addressing of high resolution arrays of first pixels 222A.

In FIGS. 10A-D, the first pixels 222A of the first SLM 48A are distributed in the lateral direction 195 (48A) and also distributed in the transverse direction 197 (48A) so that the light output from the transverse anamorphic component 60 is directed in the directions that are distributed in the transverse direction 197 and the light output from the lateral anamorphic component 110 is directed in the directions that are distributed in the lateral direction 195 when output towards the pupil 44 of the eye 45.

White first pixels 222A comprising red, green and blue sub-pixels 222AR, 222AG, 222AB are provided spatially separated in the lateral direction 195 and the sub-pixels 222AR, 222AG, 222AB are elongate with a pitch P_{L} in the lateral direction that is greater than the pitch P_{T} in the transverse direction 197.

It may be desirable to provide square white pixels in the final perceived virtual image 30 from the retinal image 36. The pitch P_{L} is magnified by the lateral anamorphic component to an angular size ϕ_{L} (with spatial pitch δ_{L} at the retina 46) and the pitch P_{T} is magnified by the transverse anamorphic component to an angular size ϕ_{T} (with spatial pitch δ_{T} at the retina 46). The pitches P_{L}, P_{T} may be determined by said different angular magnifications to advantageously achieve square angular pixels from the anamorphic first illumination system 102A.

The first pixels 222A are arranged as columns 221L, wherein the columns 221L are distributed in the lateral direction 195, and the pixels along the columns 221L are distributed in the transverse direction 197; and the first pixels 222A are further arranged as rows 221T, wherein the rows 221T are distributed in the transverse direction 197, and the pixels along the rows 221T are distributed in the lateral direction 195.

In the anamorphic first illumination system 102A of the present embodiments, the distance fᵣ between the first principal plane of the transverse anamorphic component 60 of the optical system 250 is different to the distance f_{L} between the first principal plane of the lateral anamorphic component 110 of the optical system 250. Similarly, for a square output field of view (ϕ_{T} is the same as ϕ_{L}), the separation D_{T} of pixels 222T, 222D in the transverse direction is different to the separation D_{L} of pixels 222R, 222L in the lateral direction 195.

In the present disclosure, the lateral angular magnification M_{L} provided by the lateral anamorphic component 110 may be given as

$${M}_{L} = ϕ {p}_{L} / {P}_{L} \qquad eqn . 5$$

and the transverse angular magnification M_{T} provided by the transverse anamorphic component 60 may be given as:

$${M}_{T} = ϕ {p}_{T} / {P}_{T} \qquad eqn . 6$$

where ϕp_{DL} is the angular size of a virtual pixel 32 seen by the eye in the lateral direction 195, P_{L} is the pixel pitch in the lateral direction 195, ϕp_{T} is the angular size of a virtual pixel 32 seen by the eye in the transverse direction 197, and P_{T} is the pixel pitch in the transverse direction 197. In the case that the angular virtual pixels 32 are square, then ϕp_{L} and ϕp_{T} are equal and the angular magnification provided by the lateral anamorphic component 110 may be given as:

$${M}_{L} = {M}_{T} * {P}_{T} / {P}_{L} \qquad eqn . 7$$

The angular magnification M_{L}, M_{T} of the lateral and transverse anamorphic optical elements 110, 60 is proportional to the respective optical power K_{L}, K_{T} of said elements 60, 110. The first SLM 48A may comprise pixels 222 having pitches P_{L}, P_{T} in the lateral and transverse directions 195, 197 with a ratio P_{L}/P_{T} that is the same as K_{T}/K_{L}, being the inverse of the ratio of optical powers of the lateral and transverse anamorphic optical elements 110, 60.

In FIG. 10A, the sub-pixels 222AR, 222AG, 222AB are distributed in columns of red, green, and blue pixels. Advantageously vertical and horizontal image lines may be provided with high fidelity.

In the alternative embodiment of FIG. 10B, the sub-pixels 222AR, 222AG, 222AB are distributed along diagonal lines. Advantageously reproduction of natural imagery may be improved in comparison to the embodiment of FIG. 10A.

The sub-pixels 222AR, 222AG, 222AB may be provided by white light emission and patterned colour filters, or may be provided by direct emission of respective coloured light. The present embodiments comprise sub-pixel 222A pitch P_{L} that is larger than other known arrangements comprising a symmetric input lens for thin waveguides.

In the alternative embodiment of FIG. 10C, multiple blue pixels 222AB1 and 222AB2 may be provided. The blue pixels 222AB1, 222AB2 may be driven with reduced current for a desirable output luminance. Advantageously the lifetime of the pixels may be improved, for example when the first SLM 48A is provided by an OLED microdisplay. In other embodiments, additional or alternative white pixels (for example with no colour filters) or a fourth colour such as yellow may be provided. Alternatively, different colour emission spectral bands may be provided by the first and second spatial light modulators 48A, 48B and/or by the first and second illumination systems 102A, 102B. Colour gamut and/or brightness and efficiency may advantageously be achieved.

In the alternative embodiment of FIG. 10D, the footprint of the red sub-pixels 222AR is larger than that of the green and blue sub-pixels. In micro-LED displays, small red-emitting pixels may be provided by AlInGaP material system, compared to InGaN material system for green and blue emitters. Such red emitters have reabsorption losses that increase with shrinking pixel size. Advantageously the red micro-LED emitter size is increased and display efficiency is improved. Similarly for OLED pixels, it may be desirable to provide larger blue pixels than red or green pixels to increase display lifetime.

It may be desirable to provide an ANEDA 100 comprising multiple different virtual image planes 41A, 41B.

It may be desirable to provide a stereoscopic display device.

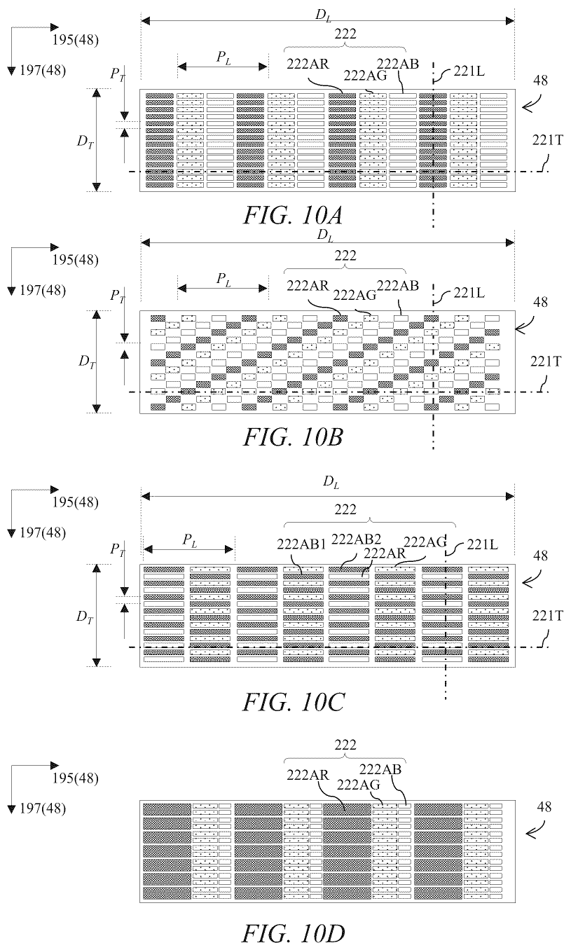

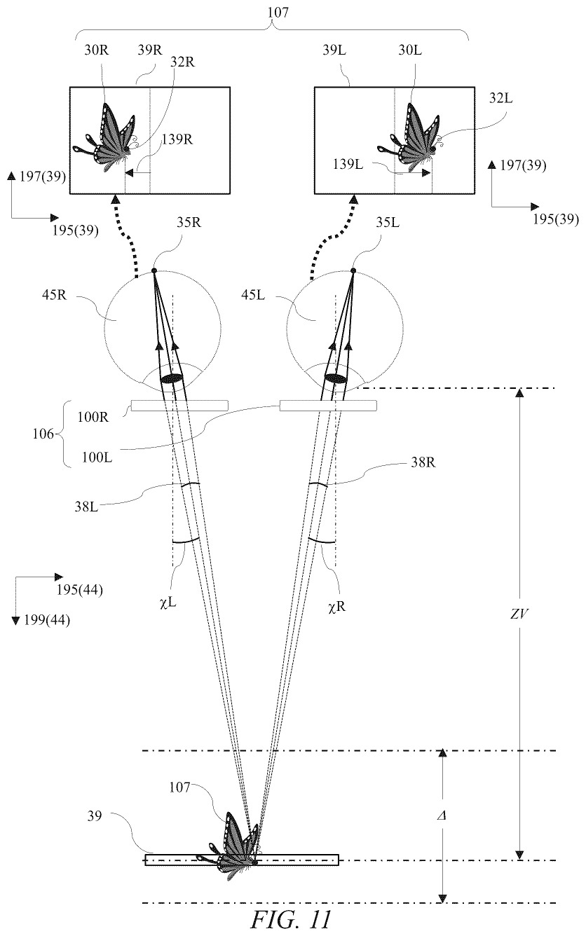

FIG. 11 is a schematic diagram illustrating a top view of a stereoscopic ANEDA display device 106 incorporating front views of virtual images 30R. 30L arranged to provide a perceived stereoscopic virtual image at a finite viewing distance ZV. Features of the embodiment of FIG. 11 not discussed in further detail may be assumed to correspond to the features with equivalent reference numerals as discussed above, including any potential variations in the features.

The alternative embodiment of FIG. 11 illustrates a stereoscopic display apparatus 106 comprising a left-eye ANEDA 100L and a right-eye ANEDA 100R that may be of the same type or different types as described hereinabove.

Virtual image 107 is provided at the viewing distance ZV with focused image points 35L, 35R at the retinas 46L, 46R of the left and right eyes 45L, 45R respectively. The virtual images 39R, 39L comprise image points 32L. 32R that have respective disparities 139L, 139R, for example from the image 39 centre. The disparities are arranged such that the convergence angles χL, χR provide a nominal convergence distance near to the viewing distance ZV, for example within a convergence distance of Δ about the viewing distance ZV.

Advantageously, convergence-accommodation mismatch is reduced for virtual images that are near to the observer 47, for example at distances around 2 metres. Visual comfort of display use is improved.

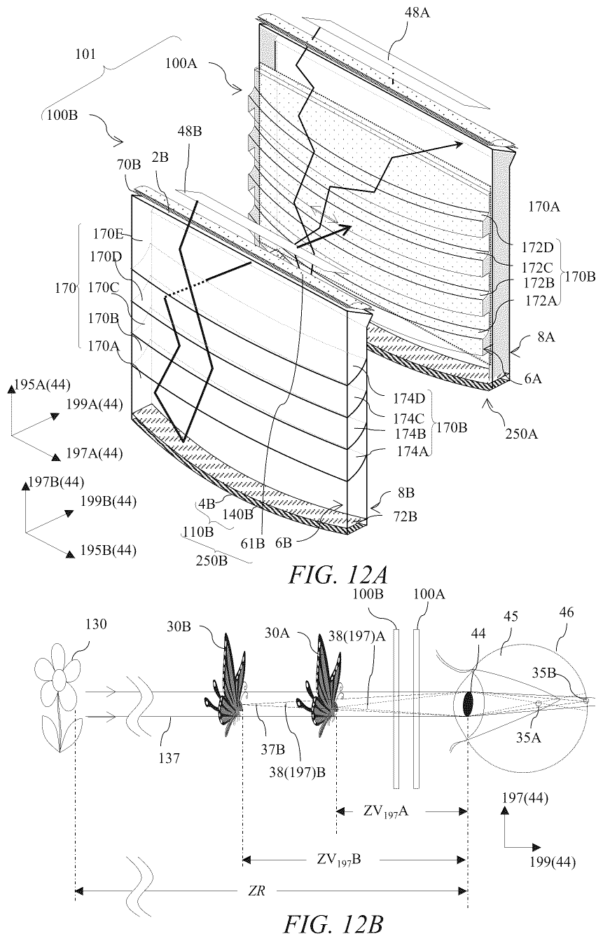

FIG. 12A is a schematic diagram illustrating a rear perspective view of an alternative near-eye display apparatus 101 arranged to provide first and second virtual images 34A. 34B at finite viewing distances ZV_{A}, ZV_{B} and further comprises two different ANEDAs 100A, 100B arranged in series; and FIG. 12B is a schematic diagram illustrating a side view of the operation of the arrangement of FIG. 12A. Features of the embodiments of FIGS. 12A-B not discussed in further detail may be assumed to correspond to the features with equivalent reference numerals as discussed above, including any potential variations in the features.

By way of comparison with the embodiment of FIG. 1A, the alternative embodiment of FIG. 18A illustrates that the first ANEDA 100A comprises an optical system 250A that has an optical axis 199A and positive optical power in lateral and transverse directions 195A, 197A that are perpendicular to each other and perpendicular to the optical axis 199A, and wherein the first ANEDA 100A has anamorphic properties in the lateral and transverse directions 195A, 197A. The second ANEDA 100B comprises an optical system 250B that has an optical axis 199B and positive optical power in lateral and transverse directions 195B, 197B that are perpendicular to each other and perpendicular to the optical axis 199B, and wherein the second ANEDA 100B has anamorphic properties in the lateral and transverse directions 195B, 197B.

In the alternative embodiment of FIG. 12A, the first optical system 250A is of the type illustrated in FIG. 7A and the second optical system 250B is of the type illustrated in FIG. 1A for example, wherein the extraction mechanisms are different. Advantageously different extraction efficiencies may be achieved. The optical power of the second optical system 250B may be different to the optical power of the first optical system 250A to advantageously achieve the different optical properties described elsewhere herein.

FIG. 12B illustrates the ANEDA 100A provides divergence 38 (197) A and the ANEDA 100B provides divergence 38 (197) B such that virtual images 30A. 30B are provided at respective viewing distances ZV₁₉₇A, ZV₁₉₇B. Advantageously improved comfort may be provided for virtual images. In an illustrative example, the distance ZV₁₉₇A may be 1 metre, and the distance ZV₁₉₇B may be 2 metres for example.

The near-eye display apparatus 101 may further be provided in the stereoscopic display device 106 of FIG. 11 to provide increased image depth for which comfortable stereoscopic images without undesirable convergence-accommodation mismatch.

It may be desirable to provide multiple focal planes for near-eye displays comprising non-anamorphic display devices.

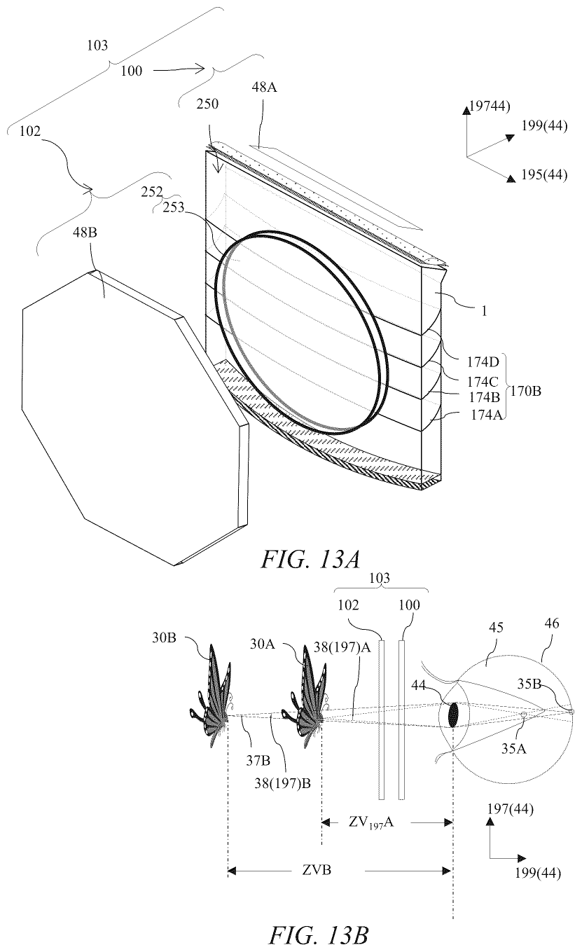

FIG. 13A is a schematic diagram illustrating a rear perspective view of an alternative near-eye display apparatus 100 arranged to provide first and second virtual images 30A, 30B at a finite viewing distance Z_{A}, Z_{B} and comprising a non-anamorphic display device 102 and an ANEDA 100 arranged in series; and FIG. 13B is a schematic diagram illustrating a side view of the operation of the arrangement of FIG. 13A. Features of the embodiments of FIGS. 13A-B not discussed in further detail may be assumed to correspond to the features with equivalent reference numerals as discussed above, including any potential variations in the features.

By way of comparison with FIGS. 12A-B, the alternative embodiments of FIGS. 13A-B comprise the ANEDA 100 comprising anamorphic SLM 48A and anamorphic optical system 250; and a non-anamorphic display comprising a non-anamorphic SLM 48 and non-anamorphic optical system 252.

The anamorphic optical system may be of the type of FIG. 1A or alternatives as described elsewhere hereinabove.

The non-anamorphic optical system 252 comprises a lens arrangement 253 and has positive optical power for the light output by the second spatial light modulator 48B. As will be described further hereinbelow, the non-anamorphic optical system 252 may comprise one or more lenses with rotational symmetry of optical power that may comprise one or more surfaces with spherical or aspherical shape profiles. The non-anamorphic optical system 252 may provide optical powers that are the same with respect to the lateral and transverse directions 195 (44), 197 (44) for light output towards the pupil 44 of the eye 45 wherein the optical powers are most typically rotationally symmetric.

Further, the spatial light modulator 48B comprises pixels 222B that are imaged in a non-anamorphic manner, that is pixels 222B with a given aspect ratio are imaged to image points in the image 31B on the retina 46 that have the same given aspect ratio. The lens arrangement 253 may comprise glass or plastic lenses that may be singlets or compound lenses. Alternative embodiments of the non-anamorphic optical system 252 are described in FIGS. 14A-B hereinbelow. The spatial light modulator 48B typically has a different size to the spatial light modulator 48A, and the pixels 222B are different in size to the pixels 222A. As will be described hereinbelow, the light emission and light control structure of the pixels 222B may be different to the light emission and light control structure of the pixels 222A.

Considering the directions of operation of the second illumination system 102B, lateral directions 195 (48B), 195 (50B) are the same; the transverse directions 197 (48B), 197 (50B) are the same and may be the same as the directions 195 (44), 197 (44).

Arrangements of the non-anamorphic optical system 250 will now be described.

FIG. 14A is a schematic diagram illustrating a side view of the operation of an alternative arrangement of a near-eye display apparatus 103 comprising an ANEDA 100 arranged to receive light from a non-ANEDA 102 comprising optical system 250 that comprises a lens arrangement 253 that is a Fresnel lens 254; and clean-up polariser 90; and FIG. 14B is a schematic diagram illustrating a side view of the operation of an alternative arrangement of a near-eye display apparatus 103 comprising an ANEDA 100 arranged to receive light from a non-ANEDA 102 comprising a Pancake lens 258. Features of the embodiments of FIGS. 14A-B not discussed in further detail may be assumed to correspond to the features with equivalent reference numerals as discussed above, including any potential variations in the features.

In the alternative embodiment of FIG. 14A, lens arrangement 253 comprises a Fresnel lens 254 that comprises a Fresnel surface 256A and a curved surface 256B. Advantageously the thickness of the lens arrangement 253 may be reduced. In operation, the lens arrangement 253 outputs light rays 234BC from pixels 222BC of the SLM 48B that have a divergence 38B that is the same in the lateral and transverse directions 195, 197. Said divergence 38B may be provided by reducing the optical power of the lens arrangement 253 in comparison to a lens that provides collimated light from a pixel 222B with substantially no divergence, for example with a 0.5 dioptre reduction of optical power to achieve a 2 metre viewing distance ZVB.

The ANEDA 100 may provide a viewing distance ZV₁₉₇A that may be for example 1 metre. Alternatively the distance ZV₁₉₇A may be greater than the distance ZVB. Advantageously the nearer virtual image 30B may be provided with higher resolution, for example for reading text while the further virtual image 30A may provide background imagery.

By way of comparison with FIG. 14A, in the alternative embodiment of FIG. 14B, the lens arrangement 253 comprises a pancake lens 258. The illustrative pancake lens 250 of FIG. 14B comprises meniscus lens 255A and plano-convex lens 255B. A half mirror 670 is arranged on the front side of the meniscus lens 255A and a reflective polariser 676 is arranged on the rear side of the plano-convex lens 255B. A retarder 672 such as a quarter waveplate is arranged to convert a linear polarisation state to a circular polarisation state and is arranged between the half mirror 670 and reflective polariser 676. Clean-up polariser 90 may achieve improved contrast for the second virtual image 30B.

The pancake lens 258 has a folded optical path as illustrated, arising from the reflection and transmission of polarised light within the pancake lens 258. Advantageously the optical aberrations are improved in comparison to the Fresnel lens of FIG. 14A. The total optical thickness from the pancake lens 258 to the SLM 48B is reduced, reducing the total system thickness.

Arrangements comprising anamorphic near-eye displays 100 and non-anamorphic displays 102 are described further in U.S. patent application Ser. No. 18/947,126 filed Nov. 14, 2024 (Atty. Ref. No. 503001), which is herein incorporated by reference in its entirety. Variations of extraction features 169 of the ANEDA 100 described herein may be arranged to achieve the divergence 38 of the output light 34 and allow the eye 45 of the viewer 47 to focus the output light 34 from a finite viewing distance ZV in at least one of the transverse direction 197 and lateral direction 195 as described elsewhere herein.

It may be desirable to provide further adjustment of virtual image distances Z_{A}, Z_{B}.

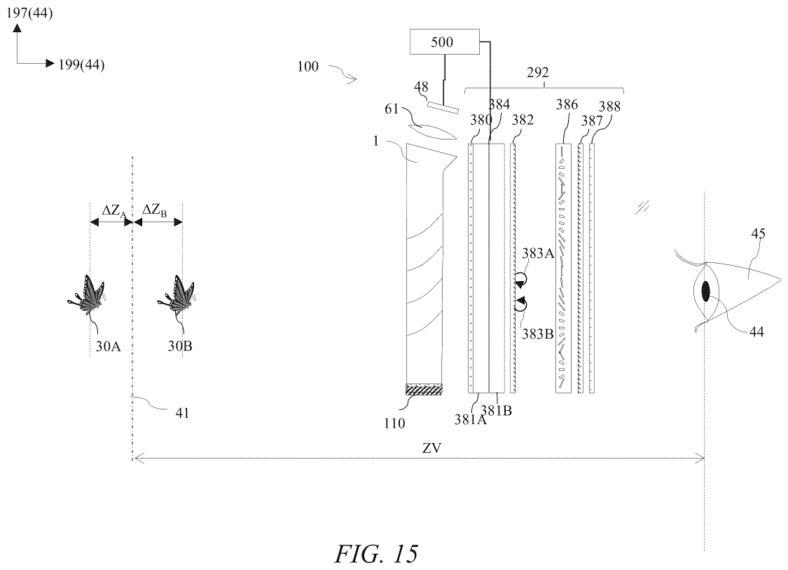

FIG. 15 is a schematic diagram illustrating in side view an alternative near-eye display apparatus further comprising Switchable Pancharatnam-Berry lens 292 arranged to provide adjustable focal distances Z for virtual images 30 from the ANEDA 100. Features of the embodiment of FIG. 15 not discussed in further detail may be assumed to correspond to the features with equivalent reference numerals as discussed above, including any potential variations in the features.

It may be desirable to provide modification of the distances Z_{V} to the virtual image planes 41 of the virtual image 30 provided by the ANEDA 100.

The Switchable Pancharatnam-Berry lens 292 is a focal plane 41 modifying lens for providing the virtual image 30 such that the distance ZV is controllable. Such an arrangement may provide suitable accommodation cues for the display user 47 such that virtual images that are desirably close to the user 47 are provided at desirable accommodation distances. In stereoscopic display applications such as illustrated in FIG. 11, the accommodation correction of the Switchable Pancharatnam-Berry lens 292 may be arranged to approximate the convergence distance of the imagery. Accommodation-convergence mismatch may be reduced and advantageously visual stress reduced, increasing comfort of use.

Switchable Pancharatnam-Berry lens 292 comprises input polariser 380, transparent substrates 381A, 381B with an electrically switchable liquid crystal layer 384 provided therebetween and a quarter-wave retarder 382. In a first state, the liquid crystal layer 384 is arranged to provide no polarisation rotation of the polarised light from the polariser 380 and the switchable optical stack 292 provides a first circularly polarised output polarisation state 383A. In a second state, the liquid crystal layer 384 is arranged to provide a polarisation rotation of the polarised light from the polariser 380 and the switchable optical stack 292 provides a second circularly polarised output polarisation state 383B, orthogonal to the polarisation state 383A.

The layer 386 comprises a circularly symmetric alignment of liquid crystal molecules with a radial phase profile similar to profile. The output polarisation state from the layer 386 is analysed by quarter-wave retarder 387 and linear polariser 388. Further description of layer 386 is described in further detail in U.S. Patent Publ. No. 2024-0427123, which is herein incorporated by reference in its entirety.

Considering the virtual image 30, and in the absence of the Pancharatnam-Berry lens 292 would provide virtual image at distance ZV. In the first state of the liquid crystal layer 384, the virtual image 30A is provided with separation ΔZ_{A} from the distances ZV; and in the second state of the liquid crystal layer 384, the virtual images 30B is provided.

Switchable Pancharatnam-Berry lens 292 thus achieve adjustable accommodation distance for virtual image 30. Stacks of Switchable Pancharatnam-Berry lens 292a-n with for example a geometric sequence of optical power adjustments may be provided to achieve increased fidelity in location of the virtual image 30. Accommodation conflicts with the provided imagery may advantageously be reduced and image comfort increased. Comfortable usage time for the head-worn display apparatus 600 may be extended.

Further corrective lenses 290 such as illustrated in FIG. 5A may be further provided to achieve further modification of viewing distances ZV.

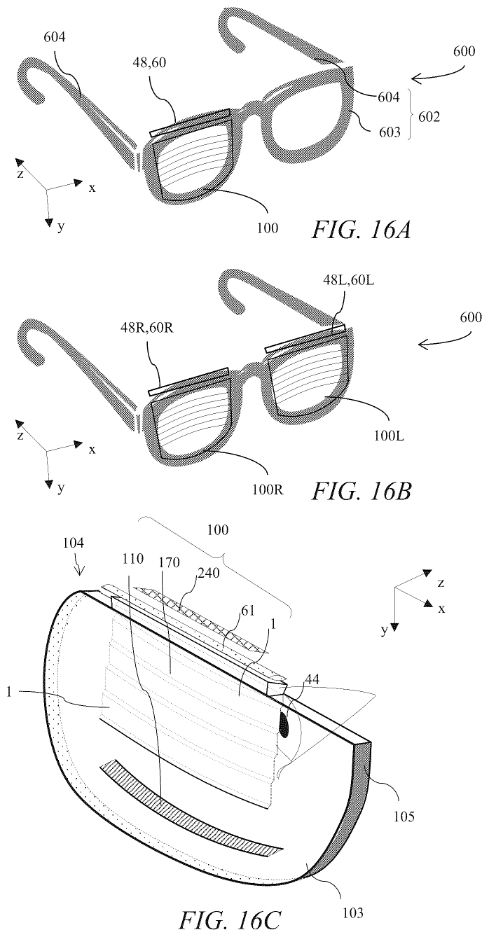

FIG. 16A is a schematic diagram illustrating in rear perspective view AR head-worn display apparatus 600 comprising a monocular anamorphic display apparatus arranged with SLM 48 and transverse anamorphic component 60 formed by the transverse lens 61 in brow position; and FIG. 16B is a schematic diagram illustrating in rear perspective view AR head-worn display apparatus 600 comprising binocular ANEDAs 100L, 100R arranged with SLMs 48R, 48L and transverse anamorphic components 60R, 60L in brow position. Features of the embodiments of FIGS. 16A-B not discussed in further detail may be assumed to correspond to the features with equivalent reference numerals as discussed above, including any potential variations in the features.

The head-worn display apparatus 600 of FIGS. 16A-B each comprise at least one ANEDA 100 and a head-mounting arrangement 602 arranged to mount the ANEDA 100 on a head of a wearer with the ANEDA 100 extending across at least one eye 45 of the wearer.

The head-worn display apparatus 600 may comprise a pair of spectacles comprising the ANEDA 100 described elsewhere herein that is arranged to extend across at least one eye 45 of a viewer 47 when the head-worn display apparatus 600 is worn. The head-worn display apparatus 600 may comprise a pair of spectacles comprising spectacle frames with the head-mounting arrangement 602 comprising rims 603 and arms 604. In general, any other head-mounting arrangement may alternatively be provided. The rims 602 and/or arms 604 may comprise electrical systems for at least power, sensing and control of the illumination system 240. The ANEDA 100 of the present embodiments may be provided with low weight and may be transparent. The head-worn display apparatus 600 may be tethered by wires to remote control system or may be untethered for wireless control. Advantageously comfortable viewing of AR, mixed reality or virtual reality (VR) content may be provided.

It may be desirable to provide improved aesthetic appearance of the ANEDA 100.

FIG. 16C is a schematic diagram illustrating in rear perspective view an eyepiece arrangement 102 for an AR head-worn display apparatus 600 comprising an embedded display apparatus 100. Features of the embodiment of FIG. 16C not discussed in further detail may be assumed to correspond to the features with equivalent reference numerals as discussed above, including any potential variations in the features.

The eyepiece arrangement 102 may be arranged within the head-worn display apparatus 600 and may comprise the ANEDA 100. The extraction waveguide 1 may be embedded with a substrate 103 that extends around the components 111, 110 of the ANEDA 100. The shape of the substrate 103 may be profiled to fit various shaped head-worn display apparatus, for example spectacles. Advantageously aesthetic appearance may be improved.

The edge 105 of the substrate 103 may be provided with a light absorbing surface that absorbs incident light from the ANEDA 100. The light absorbing surface may be a structured anti-reflection surface that is coated with an absorbing material. Advantageously image contrast is improved.

Head-worn display apparatuses 600 will now be described.

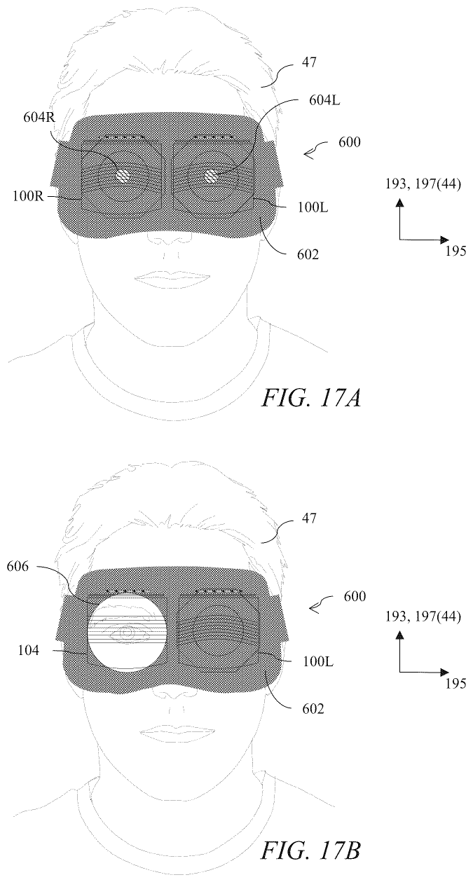

FIG. 17A is a schematic diagram illustrating a rear view of a head-worn display apparatus 600 comprising a left-eye ANEDA 100L and a right-eye ANEDA 100R and a head-mounting arrangement 602; and FIG. 17B is a schematic diagram illustrating a rear view of a head-worn display apparatus 600 comprising a left-eye ANEDA 100L and a right-eye ANEDA 100R and a head-mounting arrangement 602 wherein the right-eye ANEDA 100R transmits light from external objects 130. Features of the embodiment of FIGS. 17A-B not discussed in further detail may be assumed to correspond to the features with equivalent reference numerals as discussed above, including any potential variations in the features.

The head-worn display apparatus 600 comprises: the near-eye display apparatus 100 of any preceding embodiments or alternatives therein; and a head-mounting arrangement 602 for mounting the near-eye display apparatus 100 on the head of a user 47.

In the embodiment of FIG. 17A, the head-worn display apparatus 600 comprises left-eye and right-eye ANEDAs 100L, 100R respectively. Cameras 604L, 604R may further be provided to record pass-through image data of the outside world.

In the alternative embodiment of FIG. 17B, an aperture 606 is arranged to transmit light from external scenes, and further the near-eye display apparatus 100 is transmissive to light from external scenes. Advantageously at least one of cameras 604L, 604R may be omitted to achieve improved visibility of external scenes and improve user 47 safety. In an alternative embodiment, a shutter (not shown) such as a mechanical shutter or a liquid crystal shutter may be provided to block or reduce light from the external scene passing through the illumination apparatus 104 to the right eye 45R. Switching between a virtual reality mode of operation and an augmented reality mode of operation may be provided.

While various embodiments in accordance with the principles disclosed herein have been described above, it should be understood that they have been presented by way of example only, and not limitation. Thus, the breadth and scope of this disclosure should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 CFR 1.77 or otherwise to provide organizational cues. These headings shall not limit or characterize the embodiment(s) set out in any claims that may issue from this disclosure. Specifically and by way of example, although the headings refer to a “Technical Field.” the claims should not be limited by the language chosen under this heading to describe the so-called field. Further, a description of a technology in the “Background” is not to be construed as an admission that certain technology is prior art to any embodiment(s) in this disclosure. Neither is the “Summary” to be considered as a characterization of the embodiment(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

1. An anamorphic near-eye display apparatus comprising:
an illumination system comprising a spatial light modulator, the illumination system being arranged to output light; and
an optical system arranged to direct light from the illumination system to an eye of a viewer, wherein the optical system has an optical axis and has anamorphic properties in a lateral direction and a transverse direction that are perpendicular to each other and perpendicular to the optical axis, wherein the spatial light modulator comprises pixels distributed in the lateral direction, and
the optical system comprises:
a transverse anamorphic component having positive optical power in the transverse direction, wherein the transverse anamorphic component is arranged to receive light from the spatial light modulator and the illumination system is arranged so that light output from the transverse anamorphic component is directed in directions that are distributed in the transverse direction;
an extraction waveguide arranged to receive light from the transverse anamorphic component;
a lateral anamorphic component having positive optical power in the lateral direction, the extraction waveguide being arranged to guide light from the transverse anamorphic component to the lateral anamorphic component along the extraction waveguide in a first direction; and
a light reversing reflector that is arranged to reflect light that has been guided along the extraction waveguide in the first direction so that the reflected light is guided along the extraction waveguide in a second direction opposite to the first direction;
wherein:
the extraction waveguide comprises an array of extraction features, the extraction features being arranged to transmit light guided along the extraction waveguide in the first direction and to extract light guided along the extraction waveguide in the second direction such that the extracted light is output light that is directed towards the eye of the viewer, the array of extraction features being distributed along the extraction waveguide so as to provide exit pupil expansion; and
the extraction features have tilts that vary along the extraction waveguide in the second direction such that the output light from each point of the spatial light modulator has vergence in the transverse direction and, when the output light is viewed by the eye of the viewer, the vergence allows the eye of the viewer to focus the output light from a finite viewing distance in the transverse direction.

2. An anamorphic near-eye display apparatus according to claim 1, wherein, in the transverse direction, each extraction feature is linear.

3. An anamorphic near-eye display apparatus according to claim 1, wherein, in the transverse direction, each extraction feature is curved.

4. An anamorphic near-eye display apparatus according to claim 3, wherein, in the transverse direction, each extraction feature is curved with the same curvature.

5. An anamorphic near-eye display apparatus according to claim 3, wherein, in the transverse direction, each extraction feature is curved with a curvature that changes along the extraction waveguide in the second direction.

6. An anamorphic near-eye display apparatus according to claim 1, wherein the vergence in the transverse direction is divergence.

7. An anamorphic near-eye display apparatus according to claim 1, wherein the lateral anamorphic component and the extraction features are configured such that the output light from each point of the spatial light modulator has vergence in the lateral direction so that, when the output light is viewed by the eye of the viewer, the vergence of the output light allows the eye of the viewer to focus the output light from a finite viewing distance in the lateral direction.

8. An anamorphic near-eye display apparatus according to claim 7, wherein the vergence in the lateral direction is divergence.

9. An anamorphic near-eye display apparatus according to claim 8, wherein the lateral anamorphic component is configured to cause divergence in the lateral direction.

10. An anamorphic near-eye display apparatus according to claim 9, wherein the extraction features are curved with negative optical power in the lateral direction to cause divergence in the lateral direction.

11. An anamorphic near-eye display apparatus according to claim 9, wherein the extraction features are linear in the lateral direction to cause no change of the vergence of the output light in the lateral direction.

12. An anamorphic near-eye display apparatus according to claim 9, wherein the extraction features are curved with positive optical power in the lateral direction to reduce the divergence caused by the lateral anamorphic component in the lateral direction.

13. An anamorphic near-eye display apparatus according to claim 12, wherein each extraction feature is curved in the lateral direction with a curvature that changes along the extraction waveguide in the second direction.

14. An anamorphic near-eye display apparatus comprising:
an illumination system comprising a spatial light modulator, the illumination system being arranged to output light; and
an optical system arranged to direct light from the illumination system to an eye of a viewer, wherein the optical system has an optical axis and has anamorphic properties in a lateral direction and a transverse direction that are perpendicular to each other and perpendicular to the optical axis, wherein the spatial light modulator comprises pixels distributed in the lateral direction, and
the optical system comprises:
a transverse anamorphic component having positive optical power in the transverse direction, wherein the transverse anamorphic component is arranged to receive light from the spatial light modulator and the illumination system is arranged so that light output from the transverse anamorphic component is directed in directions that are distributed in the transverse direction;
an extraction waveguide arranged to receive light from the transverse anamorphic component;
a lateral anamorphic component having positive optical power in the lateral direction, the extraction waveguide being arranged to guide light from the transverse anamorphic component to the lateral anamorphic component along the extraction waveguide in a first direction; and
a light reversing reflector that is arranged to reflect light that has been guided along the extraction waveguide in the first direction so that the reflected light is guided along the extraction waveguide in a second direction opposite to the first direction,
wherein the extraction waveguide comprises an array of extraction features, the extraction features being arranged to pass light guided along the extraction waveguide in the first direction and to extract light guided along the extraction waveguide in the second direction such that the extracted light is output light that is directed towards the eye of the viewer, the array of extraction features being distributed along the extraction waveguide so as to provide exit pupil expansion; and
wherein the lateral anamorphic component and the extraction features are configured such that the output light from each point of the spatial light modulator has vergence in the lateral direction so that, when the output light is viewed by the eye of the viewer, the vergence of the output light allows the eye of the viewer to focus the output light from a finite viewing distance in the lateral direction.

15. An anamorphic near-eye display apparatus according to claim 14, wherein the vergence in the lateral direction is divergence.

16. An anamorphic near-eye display apparatus according to claim 15, wherein the lateral anamorphic component is configured to cause divergence in the lateral direction.

17. An anamorphic near-eye display apparatus according to claim 16, wherein the extraction features are curved with negative optical power in the lateral direction to cause divergence in the lateral direction.

18. An anamorphic near-eye display apparatus according to claim 16, wherein the extraction features are linear in the lateral direction to cause no change of the vergence of the output light in the lateral direction.

19. An anamorphic near-eye display apparatus according to claim 16, wherein the extraction features are curved with positive optical power in the lateral direction to reduce the divergence caused by the lateral anamorphic component in the lateral direction.

20. An anamorphic near-eye display apparatus according to claim 19, wherein each extraction feature is curved in the lateral direction with a curvature that changes along the extraction waveguide in the second direction.

21. An anamorphic near-eye display apparatus according to claim 14, wherein the extraction features are extraction features disposed internally within the extraction waveguide.

22. An anamorphic near-eye display apparatus according to claim 21, wherein the extraction features comprise extraction reflectors that extend across at least part of the extraction waveguide between front and rear guide surfaces of the extraction waveguide.

23. An anamorphic near-eye display apparatus according to claim 1, wherein the extraction waveguide has a front guide surface and a rear guide surface, and the rear guide surface comprises extraction surfaces that are the extraction features, each extraction surface being arranged to reflect light guided in the second direction towards an eye of a viewer through a front guide surface.

24. An anamorphic near-eye display apparatus according to claim 1, wherein the extraction waveguide has a front guide surface and a rear guide surface, and the rear guide surface comprises a diffractive optical element comprising the extraction features.

25. An anamorphic near-eye display apparatus according to claim 1, wherein:
the extraction waveguide comprises:
a front guide surface;
a polarisation-sensitive reflector opposing the front guide surface; and
an extraction element disposed outside the polarisation-sensitive reflector, the extraction element comprising:
a rear guide surface opposing the front guide surface; and
the array of extraction features;
the anamorphic near-eye display apparatus is arranged to provide light guided along the extraction waveguide in the first direction with an input linear polarisation state before reaching the polarisation-sensitive reflector; and
the optical system further comprises a polarisation conversion retarder disposed between the polarisation-sensitive reflector and the light reversing reflector, wherein the polarisation conversion retarder being arranged to convert a polarisation state of light passing therethrough between a linear polarisation state and a circular polarisation state, and the polarisation conversion retarder and the light reversing reflector are arranged in combination to rotate the input linear polarisation state of the light guided in the first direction so that the light guided in the second direction and output from the polarisation conversion retarder has an orthogonal linear polarisation state that is orthogonal to the input linear polarisation state;
the polarisation-sensitive reflector is arranged to reflect light guided in the first direction having the input linear polarisation state and to pass light guided in the second direction having the orthogonal linear polarisation state, so that the front guide surface and the polarisation-sensitive reflector are arranged to guide light in the first direction, and the front guide surface and the rear guide surface are arranged to guide light in the second direction; and
the array of extraction features is arranged to extract light guided along the extraction waveguide in the second direction towards an eye of a viewer through the front guide surface, the array of extraction features being distributed along the extraction waveguide so as to provide exit pupil expansion in the transverse direction.

26. An anamorphic near-eye display apparatus according to claim 25, wherein the polarisation-sensitive reflector comprises at least one of a reflective linear polariser, a liquid crystal layer or a dichroic stack.

27. A head-worn display apparatus comprising an anamorphic near-eye display apparatus according to claim 1 and a head-mounting arrangement arranged to mount the anamorphic near-eye display apparatus on a head of a wearer with the anamorphic near-eye display apparatus extending across at least one eye of the wearer.
